(19) United States
(12) Patent Application Publication
(10) Pub. No.: US 2025/0118497 A1
(43) Pub. Date: Apr. 10, 2025

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Yuki KOYAMA, Nagaokakyo-shi (JP)

(21) Appl. No.: 18/979,772

(22) Filed: Dec. 13, 2024

Related U.S. Application Data
(63) Continuation of application No. PCT/JP2023/017200, filed on May 2, 2023.

(30) Foreign Application Priority Data
Aug. 5, 2022 (JP) 2022-125558

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/1227; H01G 4/232

(57) ABSTRACT

A multilayer ceramic capacitor includes a multilayer body including dielectric layers and first and second inner electrode layers. The first inner electrode layers include first counter electrode portions facing the second inner electrode layers and first extended portions extending from the first counter electrode portions to a first end surface. The second inner electrode layers include a second counter electrode portions opposing the first inner electrode layers and second extended portions extending from the second counter electrode portions to a first side surface. The first extended portions include a first connection portion connected to straddle at least two or more of the first extended portions in the lamination direction, between the first extended portions, and the second extended portions include a second connection portion connected to straddle at least two or more of the second extended portions in the lamination direction, between the second extended portions.

This application claims the benefit of priority to Japanese Patent Application No. 2022-125558 filed on Aug. 5, 2022 and is a Continuation Application of PCT Application No. PCT/JP2023/017200 filed on May 2, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the related art, a multilayer ceramic capacitor is known as a multilayer ceramic electronic component. In general, a multilayer ceramic capacitor includes a multilayer body in which a plurality of dielectric layers and inner electrode layers are alternately laminated, and outer electrodes provided on both end surfaces of the multilayer body. For example, Japanese Unexamined Patent Application Publication No. 2003-243249 discloses a multilayer ceramic capacitor that has the above-described structure and includes a base electrode layer with the outer electrode formed by baking (refer to Japanese Unexamined Patent Application Publication No. 2003-243249).

In recent years, in a multilayer ceramic capacitor as described in Japanese Unexamined Patent Application Publication No. 2003-243249, a reduction in impedance of an electronic circuit line is accelerating, mainly in mobile device products, and there is a demand for an increase in the capacitance of a multilayer ceramic capacitor for decoupling applications.

As a method of increasing the capacitance of a multilayer ceramic capacitor, generally, there is a method of increasing the number of laminated inner electrode layers by thinning a dielectric layer and an inner electrode layer.

However, in a case where the number of laminated inner electrode layers is increased by thinning the dielectric layer and the inner electrode layer, in an inner layer portion formed by laminating a plurality of inner electrode layers and an outer layer portion formed by laminating only a plurality of dielectric layers, in a case where a balling phenomenon occurs where the inner electrode layer aggregates in a length direction and a width direction and expands in a height direction (lamination direction), and thereby the thickness increases, by heat during firing of the multilayer body, in an end surface portion functioning as a structural singularity of the inner layer portion and the outer layer portion, there is a case where a tensile stress in a height direction increases and separation of the inner electrode layers is more likely to occur.

### SUMMARY OF THE INVENTION

Example embodiments of the present invention provide multilayer ceramic capacitors that each reduce or prevent separation of inner electrode layers at an end portion of a multilayer body even when a thickness of a dielectric layer or the like decreases.

A multilayer ceramic capacitor according to an example embodiment of the present invention includes a plurality of laminated dielectric layers and a plurality of inner electrode layers laminated on the dielectric layers, and includes a first main surface and a second main surface facing each other in a lamination direction, a first end surface and a second end surface facing each other in a length direction orthogonal or substantially orthogonal to the lamination direction, a multilayer body including a first side surface and a second side surface facing each other in a width direction orthogonal or substantially orthogonal to the lamination direction and the length direction, a first outer electrode on the first end surface, and a second outer electrode on the second end surface, in which the plurality of inner electrode layers include a plurality of the first inner electrode layers and a plurality of the second inner electrode layers alternately provided on different dielectric layers, the plurality of the first inner electrode layers include a plurality of first counter electrode portions opposing the plurality of second inner electrode layers and a plurality of first extended portions extending from the plurality of the first counter electrode portions and extending to the first end surface, the plurality of second inner electrode layers include a plurality of second counter electrode portions opposing the plurality of first inner electrode layers and a plurality of second extended portions extending from the plurality of the second counter electrode portions and extending to the first side surface, the first extended portions each include a first connection portion connected to straddle at least two or more of first extended portions in a lamination direction between the first extended portions positioned on different dielectric layers on at least the first main surface side or at least the second main surface side, and the second extended portions each include a second connection portion connected to straddle at least two or more of second extended portions in a lamination direction between the second extended portions positioned on different dielectric layers on at least the first main surface side or at least the second main surface side.

With the multilayer ceramic capacitor according to the above-described example embodiment of the present invention, the first extended portion of the first inner electrode layer includes a first connection portion connected and straddles at least two or more of the first extended portions in a lamination direction between the first extended portions on different dielectric layers positioned on at least one of the first main surface side and the second main surface side, and the second extended portion of the second inner electrode layer includes a second connection portion connected and straddles at least two or more of the second extended portions in a lamination direction between the second extended portions on different dielectric layers positioned on at least one of the first main surface side and the second main surface side. Therefore, in the first extended portion of the first inner electrode layer and the second extended portion of the second inner electrode layer positioned on both main surface sides where separation of the multilayer ceramic capacitor is likely to occur, it is possible to improve close contact strength of inner electrode layers between the first extended portions positioned on different dielectric layers and between the second extended portions positioned on different dielectric layers. As a result, even in a case where a balling phenomenon occurs where the inner electrode layer aggregates in a lateral direction and expands in a height direction, and thus the thickness increases, by heat during firing of the multilayer body, in the inner electrode layer positioned on a portion of both end surfaces and both main surface sides of the multilayer body where separation is likely to occur, the inner electrode layers are firmly connected to each other, and thus it is possible to reduce or prevent the occurrence of separation of the inner electrode layers.

According to example embodiments of the present invention, it is possible to provide multilayer ceramic capacitors that each reduce or prevent the occurrence of separation of inner electrode layers at the end portions of the multilayer body even when the dielectric layer and the like are thinned.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an appearance perspective view illustrating an example of a two-terminal multilayer ceramic capacitor according to a first example embodiment of the present invention.

FIG. 2 is a front view illustrating an example of a two-terminal multilayer ceramic capacitor according to a first example embodiment of the present invention.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 3.

FIG. 6 is an enlarged view illustrating a configuration of a connection portion of the two-terminal multilayer ceramic capacitor according to the first example embodiment of the present invention, in a region R1 in FIG. 3.

FIG. 7 is an appearance perspective view illustrating an example of a three-terminal multilayer ceramic capacitor according to a second example embodiment of the present invention.

FIG. 8 is a top view illustrating an example of a three-terminal multilayer ceramic capacitor according to a second example embodiment of the present invention.

FIG. 9 is a front view illustrating an example of a three-terminal multilayer ceramic capacitor according to a second example embodiment of the present invention.

FIG. 10 is a cross-sectional view taken along line X-X in FIG. 7.

FIG. 11 is a cross-sectional view taken along line XI-XI in FIG. 7.

FIG. 12 is a cross-sectional view taken along line XI-XI in FIG. 11.

FIG. 13 is a cross-sectional view taken along line XII-XII in FIG. 11.

### DETAILED DESCRIPTION OF THE EXAMPLE EMBODIMENTS

Example embodiments of the present invention will be described in detail below with reference to the drawings.

### A. First Example Embodiment

### 1. Two-Terminal Multilayer Ceramic Capacitor

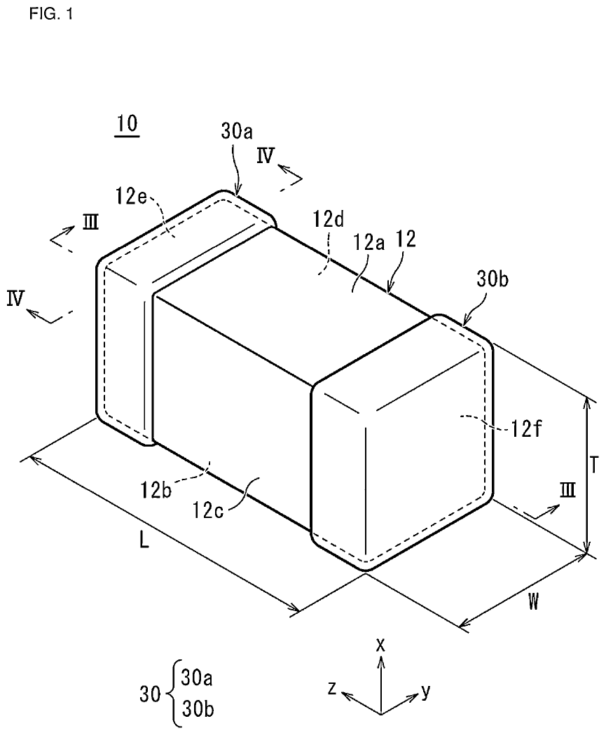

As a multilayer ceramic capacitor according to a first example embodiment of the present invention, a two-terminal multilayer ceramic capacitor 10 will be described with reference to FIGS. 1 to 5.

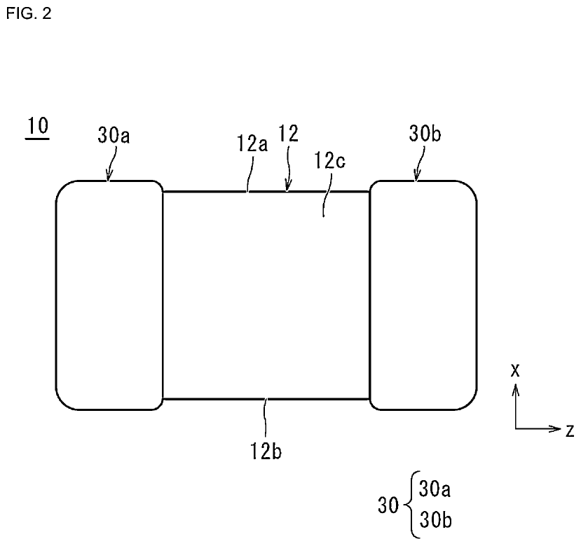

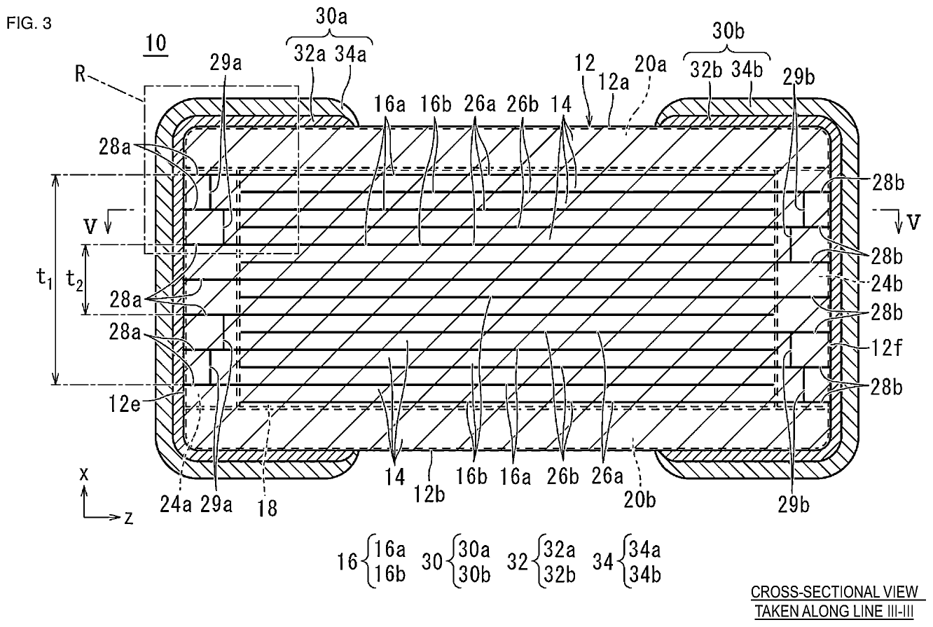

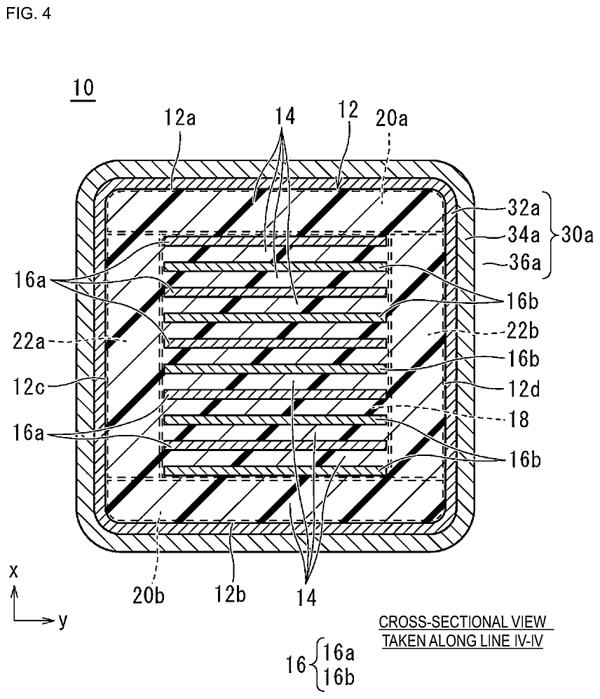

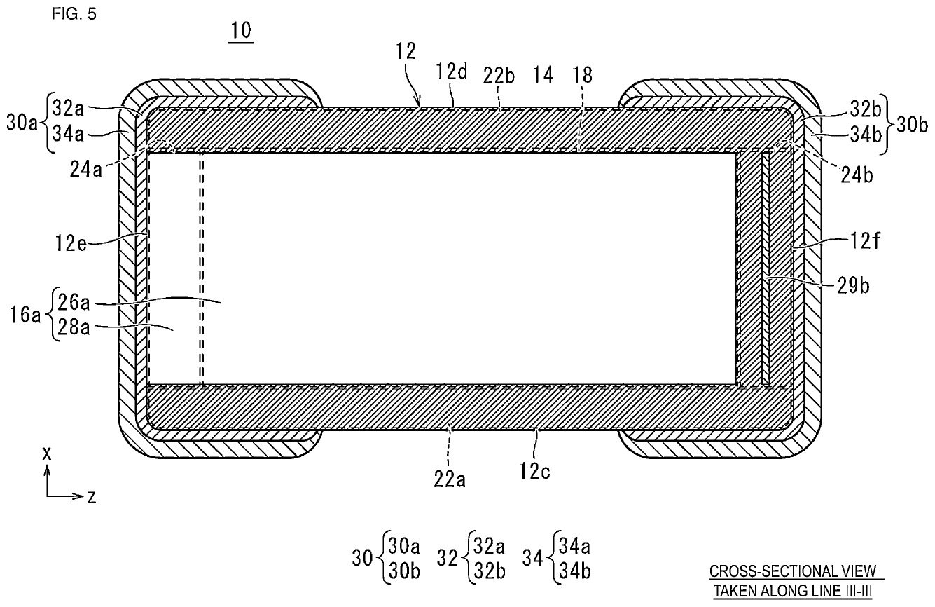

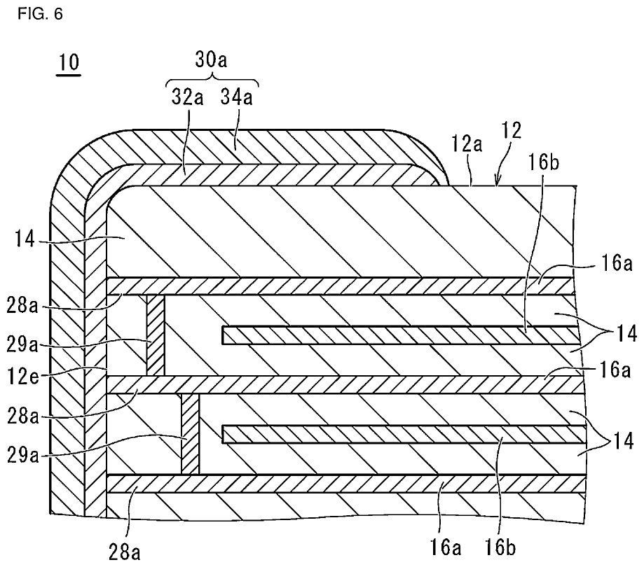

FIG. 1 is an appearance perspective view illustrating an example of a two-terminal multilayer ceramic capacitor according to a first example embodiment of the present invention. FIG. 2 is a front view illustrating an example of a two-terminal multilayer ceramic capacitor according to a first example embodiment of the present invention. FIG. 3 is a cross-sectional view taken along line III-III in FIG. 1. FIG. 4 is a cross-sectional view taken along line IV-IV in FIG. 1. FIG. 5 is a cross-sectional view taken along line V-V in FIG. 3. FIG. 6 is an enlarged view illustrating a configuration of a connection portion of the two-terminal multilayer ceramic capacitor according to the first example embodiment of the present invention, in a region R1 in FIG. 3.

As illustrated in FIGS. 1 to 4, the two-terminal multilayer ceramic capacitor 10 includes a multilayer body 12 and an outer electrode 30 disposed on a surface of the multilayer body 12.

As illustrated in FIGS. 1 to 4, the two-terminal multilayer ceramic capacitor 10 includes a rectangular or substantially rectangular parallelepiped multilayer body 12 and outer electrodes 30 disposed at both end portions of the multilayer body 12.

The multilayer body 12 includes a plurality of laminated dielectric layers 14 and a plurality of inner electrode layers 16 laminated on the dielectric layer 14. In addition, the multilayer body 12 includes a first main surface 12a and a second main surface 12b facing each other in a lamination direction x, a first side surface 12c and a second side surface 12d facing each other in a width direction y orthogonal or substantially orthogonal to the lamination direction x, and a first end surface 12e and a second end surface 12f facing each other in a length direction Z orthogonal or substantially orthogonal to the lamination direction x and the width direction y. Corner portions and ridge portions of the multilayer body 12 are rounded. In addition, the corner portion is a portion where three adjacent surfaces of the multilayer body intersect, and the ridge portion is a portion where two adjacent surfaces of the multilayer body intersect. In addition, unevenness or the like may be provided on portions or all of the first main surface 12a and the second main surface 12b, the first side surface 12c and the second side surface 12d, and the first end surface 12e and the second end surface 12f. The dielectric layer 14 and the inner electrode layer 16 are laminated in a height direction.

The multilayer body 12 includes an inner layer portion 18 including one or a plurality of dielectric layers 14 and a plurality of inner electrode layers 16 disposed thereon. The inner electrode layer 16 includes a first inner electrode layer 16a that extends to the first end surface 12e and a second inner electrode layer 16b that extends to the second end surface 12f, and the inner layer portion 18 includes a plurality of the first inner electrode layers 16a and the second inner electrode layers 16b with the dielectric layer 14 interposed therebetween.

The multilayer body 12 includes a first main surface side outer layer portion 20a, which is positioned on the first main surface 12a side, and includes a plurality of the dielectric layers 14 positioned between the first main surface 12a, an outermost surface of the inner layer portion 18 on the first main surface 12a side, and on a straight line of the outermost surface thereof.

Similarly, the multilayer body 12 includes a second main surface side outer layer portion 20b, which is positioned on the second main surface 12b side, and includes a plurality of the dielectric layers 14 positioned between the second main surface 12b, an outermost surface of the inner layer portion 18 on the second main surface 12b side, and on a straight line of the outermost surface thereof.

The multilayer body 12 includes a first side surface side outer layer portion 22a, which is positioned on the first side surface 12c side and includes a plurality of the dielectric layers 14 positioned between the first side surface 12c and an outermost surface of the inner layer portion 18 on the first side surface 12c side.

Similarly, the multilayer body 12 includes a second side surface side outer layer portion 22b, which is positioned on the second side surface 12d side and includes a plurality of the dielectric layers 14 positioned between the second side surface 12d and an outermost surface of the inner layer portion 18 on the second side surface 12d side.

In addition, the first side surface side outer layer portion 22a and the second side surface side outer layer portion 22b are also referred to as a W gap or a side gap.

The multilayer body 12 includes a first end surface side outer layer portion 24a, which is positioned on the first end surface 12e side and includes a plurality of the dielectric layers 14 positioned between the first end surface 12e and an outermost surface of the inner layer portion 18 on the first end surface 12e side.

Similarly, the multilayer body 12 includes a second end surface side outer layer portion 24b, which is positioned on the second end surface 12f side and includes a plurality of the dielectric layers 14 positioned between the second end surface 12f and an outermost surface of the inner layer portion 18 on the second end surface 12f side.

The first end surface side outer layer portion 24a and the second end surface side outer layer portion 24b are also referred to as an L gap or an end gap.

The first main surface side outer layer portion 20a is positioned on the first main surface 12a side of the multilayer body 12, and is an aggregate of the plurality of dielectric layers 14 positioned between the first main surface 12a and the inner electrode layer 16 closest to the first main surface 12a. The dielectric layer 14 used in the first main surface side outer layer portion 20a may be the same or substantially the same to the dielectric layer 14 used in the inner layer portion 18.

The second main surface side outer layer portion 20b is positioned on the second main surface 12b side of the multilayer body 12, and is an aggregate of the plurality of dielectric layers 14 positioned between the second main surface 12b and the inner electrode layer 16 closest to the second main surface 12b.

The dielectric layer 14 can be made of a dielectric material, for example, as a ceramic material. As such a dielectric material, for example, a dielectric ceramic including a component such as BaTiO₃, CaTiO₃, SrTiO₃, or CaZrO₃ can be used. In a case where the above-described dielectric material is included as a main component, for example, those in which a sub-component having a smaller content than that of the main component such as a Mn compound, a Fe compound, a Cr compound, a Co compound, or a Ni compound is added may be used depending on characteristics of a desired multilayer body 12.

The dimension of the multilayer body 12 is not particularly limited.

The dielectric layer 14 can be made of a dielectric material, for example, as a ceramic material. As such a dielectric material, for example, a dielectric ceramic including a component such as BaTiO₃, CaTiO₃, SrTiO₃, or CaZrO₃ can be used. In a case where the above-described dielectric material is included as a main component, for example, those in which a sub-component having a smaller content than that of the main component such as a Mn compound, a Fe compound, a Cr compound, a Co compound, or a Ni compound is added may be used depending on characteristics of a desired multilayer body 12.

A thickness of the dielectric layer 14 in the multilayer body 12 after firing is, for example, about 0.5 μm or more and about 10.0 μm or less.

The number of dielectric layers 14 to be laminated is, for example, preferably 15 or more and 700 or less. However, the number of dielectric layers 14 is a total number of the number of dielectric layers 14 in the inner layer portion 18 and the number of dielectric layers of the first main surface side outer layer portion 20a and the second main surface side outer layer portion 20b.

The multilayer body 12 includes a plurality of the first inner electrode layers 16a and a plurality of the second inner electrode layers 16b as a plurality of inner electrode layers 16. The plurality of the first inner electrode layers 16a and the plurality of the second inner electrode layers 16b are parallel or substantially parallel to the first main surface 12a and the second main surface 12b, and are embedded to be alternately disposed with the dielectric layer 14 interposed therebetween along the lamination direction x of the multilayer body 12.

The first inner electrode layer 16a is disposed on the plurality of dielectric layers 14 and is positioned inside the multilayer body 12. The first inner electrode layer 16a includes a first counter electrode portion 26a opposing the second inner electrode layer 16b and a first extended portion 28a which is positioned on one end side of the first inner electrode layer 16a and extended from the first counter electrode portion 26a to the first end surface 12e of the multilayer body 12. Therefore, the end portions of the plurality of first extended portions 28a extend to the surface of the first end surface 12e and are exposed from the multilayer body 12.

A shape of the first counter electrode portion 26a of the first inner electrode layer 16a is not particularly limited, but is preferably a rectangular or substantially rectangular shape in a plan view. However, a corner portion may be rounded in a plan view or the corner portion may be provided diagonally in a plan view (tapered shape). In addition, the shape may be a tapered shape in a plan view that is inclined toward any one.

The shape of the first extended portion 28a of the first inner electrode layer 16a is not particularly limited, but is preferably a rectangular or substantially rectangular shape in a plan view. However, a corner portion may be rounded in a plan view or the corner portion may be provided diagonally in a plan view (tapered shape). In addition, the shape may be a tapered shape in a plan view that is inclined toward any one.

A width of the first counter electrode portion 26a of the first inner electrode layer 16a and a width of the first extended portion 28a of the first inner electrode layer 16a may be the same or substantially the same width, and either one may have a narrow width.

The second inner electrode layer 16b is disposed on the plurality of dielectric layers 14 and is positioned inside the multilayer body 12. The second inner electrode layer 16b includes a second counter electrode portion 26b opposing the first inner electrode layer 16a and a second extended portion 28b, which is positioned on one end side of the second inner electrode layer 16b and extended from the second counter electrode portion 26b to the second end surface 12f of the multilayer body 12. Therefore, the end portions of the plurality of second extended portions 28b extend to the surface of the second end surface 12f and exposed from the multilayer body 12.

A shape of the second counter electrode portion 26b of the second inner electrode layer 16b is not particularly limited, but is preferably a rectangular or substantially rectangular shape in a plan view. However, a corner portion may be rounded in a plan view or the corner portion may be provided diagonally in a plan view (tapered shape). In addition, the shape may be a tapered shape in a plan view that is inclined toward any one.

The shape of the second extended portion 28b of the second inner electrode layer 16b is not particularly limited, but is preferably a rectangular or substantially rectangular shape in a plan view. However, a corner portion may be rounded in a plan view or the corner portion may be provided diagonally in a plan view (tapered shape). In addition, the shape may be a tapered shape in a plan view that is inclined toward any one.

A width of the second counter electrode portion 26b of the second inner electrode layer 16b and a width of the second extended portion 28b of the second inner electrode layer 16b may be the same or substantially the same width, and either one may be formed to have a narrow width.

Here, in FIG. 6, a configuration of the connection portion of the two-terminal multilayer ceramic capacitor according to the first example embodiment of the present invention in the region R1 in FIG. 3 is illustrated.

The first extended portion 28a includes a first connection portion 29a connected and disposed to straddle at least two or more of the first extended portions 28a in a lamination direction between the first extended portions 28a disposed on different dielectric layers 14 positioned on at least one of the first main surface 12a side and the second main surface 12b side.

The second extended portion 28b includes a second connection portion 29b connected and disposed to straddle at least two or more of the second extended portions 28b in a lamination direction between the second extended portions 28b disposed on different dielectric layers 14 positioned on at least one of the first main surface 12a side and the second main surface 12b side.

The first connection portion 29a is preferably positioned on the first end surface 12e side with respect to about ½ of the dimension in a length direction z of the first end surface side outer layer portion 24a.

The second connection portion 29b is preferably positioned on the second end surface 12f side with respect to about ½ of the dimension in the length direction z of the second end surface side outer layer portion 24b.

Accordingly, in a portion in which stress concentration is most likely to occur due to a balling phenomenon where the inner electrode layer 16 aggregates in a lateral direction and expands in a height direction, and thus the thickness increases, by heat during firing of the multilayer body 12, it is possible to directly and further improve close contact strength between the inner electrode layers 16.

It is preferable that there is a plurality of first connection portions 29a.

It is preferable that there is a plurality of second connection portions 29b.

Accordingly, in a portion in which stress concentration is most likely to occur due to a balling phenomenon where the inner electrode layer 16 aggregates in a lateral direction and expands in a height direction, and thus the thickness increases, by heat during firing of the multilayer body 12, it is possible to directly and further improve close contact strength between the inner electrode layers 16.

The first connection portion 29a is preferably positioned on the first main surface 12a side excluding a central portion of the inner layer portion 18 in the lamination direction and on the second main surface 12b side excluding a central portion of the inner layer portion 18 in the lamination direction.

The second connection portion 29b is preferably positioned on the first main surface 12a side excluding a central portion of the inner layer portion 18 in a lamination direction [symbol] and on the second main surface 12b side excluding a central portion of the inner layer portion 18 in a lamination direction.

Accordingly, while reducing or preventing the occurrence of separation of the inner electrode layers 16, it is possible to maintain ceramic strength of the multilayer body 12 in a portion in which an extended portion of the inner electrode layer 16 is present in a central portion of the inner layer portion 18 in a lamination direction. Therefore, while reducing or preventing the occurrence of separation of the inner electrode layers 16, in a case where an external impact is applied to the two-terminal multilayer ceramic capacitor 10, it is also possible to reduce or prevent the occurrence of breakage, chipping, crack, or the like in the multilayer body 12 of the two-terminal multilayer ceramic capacitor 10.

At this time, a dimension t₂ in the lamination direction of the central portion of the inner layer portion 18 in the lamination direction x, which is a region where the first connection portion 29a is not disposed, is, for example, about 25% or more and about 75% or less of a dimension t₁ in the lamination direction of the inner layer portion 18.

In addition, the dimension t₂ in the lamination direction of the central portion of the inner layer portion 18 in the lamination direction, which is a region where the second connection portion 29b is not disposed, is, for example, about 25% or more and 75% or less of the dimension t₁ in the lamination direction of the inner layer portion 18.

Here, in a case where the dimension t₂ in the lamination direction of the central portion of the inner layer portion 18 in the lamination direction in the region where the first connection portion 29a and the second connection portion 29b are not disposed is less than about 25% of the dimension t₁ in the lamination direction of the inner layer portion 18, there is a concern that breakage, chipping, crack, or the like may occur in the multilayer body 12 of the two-terminal multilayer ceramic capacitor 10 in a case where an external impact is applied to the two-terminal multilayer ceramic capacitor 10. In addition, the dimension t₂ in the lamination direction of the central portion of the inner layer portion 18 in the lamination direction in the region where the first connection portion 29a and the second connection portion 29b are not disposed is more than about 75% of the dimension t₁ in the lamination direction of the inner layer portion 18, in an extended portion of the inner electrode layer 16 of the inner layer portion 18 positioned on main surface side outer layer portions 20a, 20b sides where separation of the two-terminal multilayer ceramic capacitor 10 is likely to occur, there is a case where it is not possible to sufficiently ensure close contact strength of the inner electrode layers 16 between the first extended portions 28a positioned on different dielectric layers 14 and between the second extended portions 28b positioned on different dielectric layers 14.

The dimension in the length direction z that links the first end surface 12e and the second end surface 12f of the first connection portion 29a is, for example, about 3% or more and about 97% or less with respect to the thickness of the first extended portion 28a of the first inner electrode layer 16a.

The dimension in the length direction z that links the first end surface 12e and the second end surface 12f of the second connection portion 29b is, for example, about 3% or more and about 97% or less with respect to the thickness of the second extended portion 28b of the second inner electrode layer 16b.

Accordingly, since the electric resistance is higher than that of the inner electrode layer 16 and it is difficult for current to flow, it is possible to prevent changes in electronic characteristics and reduce or prevent separation of the inner electrode layers 16 by including the first connection portion 29a and the second connection portion 29b.

The first connection portion 29a and the second connection portion 29b may be continuously disposed as in FIG. 5, or may be discontinuously disposed although not illustrated, in a width direction y in the region where the first inner electrode layer 16a and the second inner electrode layer 16b of the two-terminal multilayer ceramic capacitor 10 are disposed.

The first connection portion 29a and the second connection portion 29b are preferably concentrated in the central portion of the two-terminal multilayer ceramic capacitor 10 in the width direction y.

Accordingly, it becomes possible to further ensure the close contact strength between the inner electrode layers 16 firmly in the central portion of the two-terminal multilayer ceramic capacitor 10 in the width direction y.

A confirmation method of the first connection portion 29a and the second connection portion 29b is performed by an example of a method described below.

That is, the two-terminal multilayer ceramic capacitor 10 is polished to a position of about ½ W of the dimension in the width direction y of the two-terminal multilayer ceramic capacitor 10 such that the two-terminal multilayer ceramic capacitor 10 is parallel or substantially parallel to the first side surface 12c or the second side surface 12d, and an LT cross-section is exposed. After that, the exposed LT cross-section is observed, and the first connection portion 29a and the second connection portion 29b are confirmed by using an electron microscope.

A method of measuring the dimension in the length direction z that links the first end surface 12e and the second end surface 12f of the first connection portion 29a and the second connection portion 29b is performed by an example of a method described below.

That is, in the measurement of the dimension in the length direction z of the first connection portion 29a and the second connection portion 29b, first, the two-terminal multilayer ceramic capacitor 10 is polished to a position of about ½ W of the dimension in the width direction y of the two-terminal multilayer ceramic capacitor 10 such that the two-terminal multilayer ceramic capacitor 10 is parallel or substantially parallel to the first side surface 12c or the second side surface 12d, and the LT cross-section is exposed. After that, the exposed LT cross-section is observed, the first connection portion 29a and the second connection portion 29b are observed using an electron microscope, and the dimension in the length direction z of the first connection portion 29a and the second connection portion 29b is measured.

Specifically, a dimension in the length direction z that links the first connection portion 29a and the second connection portion 29b present from the first main surface 12a to the 10th layer toward the second main surface 12b, in the inner electrode layer 16 positioned on the first main surface 12a side, or a dimension in the length direction z that links the first end surface 12e and the second end surface 12f of the first connection portion 19a and the second connection portion 29b present from the second main surface 12b to the 10th layer toward the first main surface 12a, in the inner electrode layer 16 positioned on the second main surface 12b side, are measured, and the averaged value is denoted as the dimension in the length direction z of the first connection portion 29a and the second connection portion 29b.

The first inner electrode layer 16a and the second inner electrode layer 16b can be made of appropriate conductive materials such as a metal such as Ni, Cu, Ag, Pd, or Au, or an alloy including at least one of these metals, such as Ag—Pd alloy and the like, for example.

Each thickness of the first inner electrode layer 16a and the second inner electrode layer 16b is not particularly limited, but for example, is, for example, preferably about 0.4 μm or more and about 0.8 μm or less.

The number of each of the first inner electrode layer 16a and the second inner electrode layer 16b is not particularly limited, but the total number is, for example, preferably 2 or more and 1,000 or less.

The first inner electrode layer 16a and the second inner electrode layer 16b can be made of appropriate conductive materials such as a metal such as Ni, Cu, Ag, Pd, and Au, or an alloy including at least one of these metals, such as Ag—Pd alloy and the like, for example.

Subsequently, the outer electrode 30 is provided on the first side surface 12c and the second side surface 12d, and the first end surface 12e side and the second end surface 12f side, of the multilayer body 12, as illustrated in FIGS. 1 to 4.

The outer electrode 30 includes a first outer electrode 30a and a second outer electrode 30b.

The first outer electrode 30a is connected to the first inner electrode layer 16a and disposed on at least a surface of the first end surface 12e. In addition, the first outer electrode 30a extends from the first end surface 12e of the multilayer body 12 and is also disposed on a portion of the first main surface 12a and a part of the second main surface 12b, and a part of the first side surface 12c and a portion of the second side surface 12d. In this case, the first outer electrode 30a is electrically connected to the first extended portion 28a of the first inner electrode layer 16a.

The second outer electrode 30b is connected to the second inner electrode layer 16b and disposed on at least a surface of the second end surface 12f. In addition, the second outer electrode 30b extends from the second end surface 12f and is also disposed on a portion of the first main surface 12a and a portion of the second main surface 12b, and a portion of the first side surface 12c and a portion of the second side surface 12d. In this case, the second outer electrode 30b is electrically connected to the second extended portion 28b of the second inner electrode layer 16b.

In the multilayer body 12, the first counter electrode portion 26a of the first inner electrode layer 16a and the second counter electrode portion 26b of the second inner electrode layer 16b are opposed with the dielectric layer 14 interposed therebetween to generate electrostatic capacitance. Therefore, electrostatic capacitance can be obtained between the first outer electrode 30a to which the first inner electrode layer 16a is connected and the second outer electrode 30b to which the second inner electrode layer 16b is connected, and characteristics of the capacitor are provided.

The outer electrode 30 includes a base electrode layer 32 including a metal component and a glass component, and a plating layer 34 provided on a surface of the base electrode layer 32.

The first outer electrode 30a preferably includes a first base electrode layer 32a disposed on a surface of the first end surface 12e, and includes a first plating layer 34a disposed on a surface of the first base electrode layer 32a.

The second outer electrode 30b preferably includes a second base electrode layer 32b disposed on a surface of the second end surface 12f, and includes a second plating layer 34b disposed on a surface of the second base electrode layer 32b.

The base electrode layer 32 includes the first base electrode layer 32a and the second base electrode layer 32b.

The first base electrode layer 32a is disposed on the surface of the first end surface 12e of the multilayer body 12, and extends from the first end surface 12e and covers a portion of the first main surface 12a, the second main surface 12b, the first side surface 12c, and the second side surface 12d, respectively.

The second base electrode layer 32b is disposed on the surface of the second end surface 12f of the multilayer body 12, and extends from the second end surface 12f and covers a portion of the first main surface 12a, the second main surface 12b, the first side surface 12c, and the second side surface 12d, respectively.

In addition, the first base electrode layer 32a may be disposed only on the surface of the first end surface 12e of the multilayer body 12, and the second base electrode layer 32b may be disposed only on the surface of the second end surface 12f of the multilayer body 12.

The base electrode layer 32 includes at least one of a baked layer, a conductive resin layer, a thin film layer, and the like.

Hereinafter, each configuration in a case where the base electrode layer 32 is the baked layer, the conductive resin layer, or the thin film layer will be described.

The baked layer includes a glass component and a metal component. The glass component of the baked layer includes, for example, at least one of B, Si, Ba, Mg, Al, Li, and the like. The metal component of the baked layer includes, for example, at least one pf Cu, Ni, Ag, Pd, an Ag—Pd alloy, Au, and the like. The baked layer is obtained by applying a conductive paste including a glass component and a metal component to the multilayer body 12 and baking the conductive paste. The baked layer may be a layer obtained by simultaneously firing the multilayer chip having the inner electrode layer 16 and the dielectric layer 14 and a conductive paste applied to the multilayer chip, or may be a layer obtained by firing the conductive paste to a multilayer body after obtaining the multilayer body by firing the multilayer chip having the inner electrode layer 16 and the dielectric layer 14.

In a case where the multilayer chip including the inner electrode layer 16 and the dielectric layer 14 and the conductive paste applied to the multilayer chip are simultaneously fired, the baked layer is preferably formed by firing those in which a dielectric material is added instead of a glass component.

The baked layer may include a plurality of layers.

In a case where the first base electrode layer 32a is a baked layer, a thickness at the central portion in the lamination direction x of the first base electrode layer 32a positioned on the first end surface 12e is, for example, preferably about 3 μm or more and about 100 μm or less.

In addition, in a case where the second base electrode layer 32b is a baked layer, a thickness at the central portion in the lamination direction x of the second base electrode layer 32b positioned on the second end surface 12f is, for example, preferably about 3 μm or more and about 100 μm or less.

In addition, in a case where the base electrode layer 32 is a baked layer on the first main surface 12a and the second main surface 12b, a thickness in a direction that links the first main surface 12a and the second main surface 12b at the central portion in the length direction z of the first base electrode layer 32a positioned on the first main surface 12a and the second main surface 12b is, for example, preferably about 3 μm or more and about 70 μm or less, and a thickness in a direction that links the first main surface 12a and the second main surface 12b at the central portion in the length direction z of the second base electrode layer 32b positioned on the first main surface 12a and the second main surface 12b is, for example, preferably about 3 μm or more and about 70 μm or less.

In addition, in a case where the base electrode layer 32 is provided by a baked layer on the first side surface 12c and the second side surface 12d, a thickness in a direction that links the first side surface 12c and the second side surface 12d at the central portion in the length direction z of the first base electrode layer 32a positioned on the first side surface 12c and the second side surface 12d is, for example, preferably about 10 μm or more and about 100 μm or less, and a thickness in a direction that links the first side surface 12c and the second side surface 12d at the central portion in the length direction z of the second base electrode layer 32b positioned on the first side surface 12c and the second side surface 12d is, for example, preferably about 10 μm or more and about 100 μm or less.

In a case where a conductive resin layer is provided as the base electrode layer 32, the conductive resin layer may be disposed on the baked layer to cover the baked layer, or may be directly disposed on the multilayer body 12. However, the conductive resin layer may be disposed only on the base electrode layer 32 positioned on both end surfaces 12e and 12f.

The conductive resin layer includes a metal and a heat solidifying resin.

The conductive resin layer may completely cover the base electrode layer or may cover a portion of the base electrode layer.

Since the conductive resin layer includes a heat solidifying resin, for example, the conductive resin layer has more flexibility than a conductive layer of a plating film or a baked product of a conductive paste. Therefore, even in a case where the two-terminal multilayer ceramic capacitor 10 is subjected to a physical shock or an impact due to a thermal cycle, the conductive resin layer functions as a buffer layer, and crack to the two-terminal multilayer ceramic capacitor 10 can be prevented.

As the metal included in the conductive resin layer, for example, Ag, Cu, Ni, Sn, Bi, or an alloy including these can be used.

In addition, for example, metal powders coated with Ag can be used on a surface of the metal powders. When using metal powders coated with Ag on the surface of the metal powders, for example, Cu, Ni, Sn, Bi, or an alloy powder of these is preferably used as a metal powder. In addition, for example, Cu and Ni subjected to antioxidant treatment can also be used. The reason for using the conductive metal powder of Ag as the conductive metal is that it is possible to make the base metal inexpensive while maintaining the above-described characteristics of Ag.

The metal included in the conductive resin layer is preferably included at about 35 volt or more and about 75 vol % or less with respect to the volume of the entire conductive resin.

An average particle size of the metal included in the conductive resin layer is not particularly limited. The average particle size of the conductive filler may be, for example, about 0.3 μm or more and about 10 μm or less.

The metal included in the conductive resin layer is mainly responsible for energizing properties of the conductive resin layer. Specifically, an energizing path is formed inside the conductive resin layer when conductive fillers come into contact with each other.

As the metal included in the conductive resin layer, for example, a metal having a spherical shape or a flat shape can be used, but it is preferable that a spherical metal powder and a flat metal powder are mixed and used.

As the resin of the conductive resin layer, for example, various known heat solidifying resins such as an epoxy resin, a phenol resin, a urethane resin, a silicone resin, and a polyimide resin can be used. Among these, an epoxy resin having excellent heat resistance, moisture resistance, adhesion, and the like is one of the more appropriate resins.

In addition, it is preferable that the conductive resin layer includes a curing agent together with the heat solidifying resin. As a curing agent, in a case where an epoxy resin is used as a base resin, as a curing agent for the epoxy resin, various known compounds such as phenol, amine, acid anhydride, imidazole, active ester, and amide imide can be used.

The conductive resin layer may include a plurality of layers.

The thickness of the conductive resin layer positioned at the central portion in the lamination direction x of the multilayer body 12 positioned on the first end surface 12e and the second end surface 12f is, for example, preferably about 10 μm or more and about 150 μm or less.

The thin film layer is formed by a thin film forming method such as, for example, a sputtering method or an evaporation method, and is a layer of about 1 μm or less on which metal particles are deposited.

The plating layer 34 includes a first plating layer 34a and a second plating layer 34b.

The first plating layer 34a is disposed to cover the surface of the first base electrode layer 32a.

The second plating layer 34b is disposed to cover the surface of the second base electrode layer 32b.

The plating layer 34 may include, for example, at least one of Cu, Ni, Sn, Ag, Pd, Ag—Pd alloy, Au, and the like.

The plating layer 34 may include a single layer, or may include a plurality of layers. In a case where the plating layer 34 includes a plurality of layers, for example, a two-layer structure of Ni plating and Sn plating is preferable. By setting a layer in direct contact with the base electrode layer to be a plating layer made of Ni plating, particularly in a case where the base electrode layer is a conductive resin layer, when mounting the multilayer ceramic capacitor, it is possible to prevent the base electrode layer from being eroded due to solder used for mounting.

In addition, by setting an upper layer of the plating layer made of Ni plating to be a plating layer made of Sn plating, when mounting the two-terminal multilayer ceramic capacitor 10 on a mounting substrate, it is possible to enhance the wettability of the solder used for mounting and to easily mount thereof.

A thickness of each layer of the plating layer 34 is, for example, preferably about 1.0 μm or more and about 15.0 μm or less.

The outer electrode 30 may include only a plating layer without providing the base electrode layer 32.

Hereinafter, although not illustrated, a structure in which a plating layer is provided without providing the base electrode layer 32 will be described.

Each of the first outer electrode 30a and the second outer electrode 30b need not be provided with the base electrode layer, and a plating layer may be directly formed on a surface of the multilayer body 12. That is, the two-terminal multilayer ceramic capacitor 10 may have a structure including a plating layer electrically connected to the first inner electrode layer 16a or the second inner electrode layer 16b. In such a case, the plating layer may be formed after a catalyst is disposed on the surface of the multilayer body 12 as pretreatment.

In a case where the plating layer is formed directly on the multilayer body without providing the base electrode layer, an amount by which the thickness of the base electrode layer is reduced can be lowered in height, that is, thinned, or can be converted to the multilayer body thickness, that is, a thickness of an effective layer portion, and thus it is possible to improve a degree of freedom in design of the thickness of the multilayer body 12.

The plating layer preferably includes a lower plating electrode provided on the surface of the multilayer body 12 and an upper plating electrode provided on the surface of the lower plating electrode. It is preferable that the lower plating electrode and the upper plating electrode each include, for example, at least one of Cu, Ni, Sn, Pb, Au, Ag, Pd, Bi, Zn, and the like, or an alloy including the metal.

In addition, for example, the lower plating electrode is preferably formed using Ni having solder barrier performance, and the upper plating electrode is preferably formed using Sn or Au having favorable solder wettability.

In addition, for example, in a case where the first inner electrode layer 16a and the second inner electrode layer 16b are formed using Ni, the lower plating electrode is preferably formed using Cu having good adhesion properties to Ni. The upper plating electrode may be formed depending on the necessity, and the first outer electrode 30a and the second outer electrode 30b may each include only the lower plating electrode. The plating layer may include the upper plating electrode as the outermost layer, or other plating electrodes may be formed on the surface of the upper plating electrode.

Here, in a case where the outer electrode 30 includes only the plating layer without providing the base electrode layer 32, a thickness of each plating layer disposed without providing the base electrode layer 32 is, for example, preferably about 1.0 μm or more and about 15.0 μm or less.

In addition, it is preferable that the plating layer does not include glass. A metal ratio per unit volume of the plating layer is, for example, preferably about 99 volume % or more.

A dimension in the length direction z of the two-terminal multilayer ceramic capacitor 10 including the multilayer body 12, the first outer electrode 30a, and the second outer electrode 30b is defined as an L dimension, a dimension in the lamination direction x of the two-terminal multilayer ceramic capacitor 10 including the multilayer body 12, the first outer electrode 30a, and the second outer electrode 30b is defined as a T dimension, and a dimension in the width direction y of the two-terminal multilayer ceramic capacitor 10 including the multilayer body 12, the first outer electrode 30a, and the second outer electrode 30b is defined as a W dimension.

As for the dimensions of the two-terminal multilayer ceramic capacitor 10, for example, the L dimension in the length direction z is about 0.2 mm or more and about 11.0 mm or less, the W dimension in the width direction y is about 0.1 mm or more and about 11.0 mm or less, and the T dimension in the lamination direction x is about 0.1 mm or more and about 11.0 mm or less. In addition, the dimensions of the two-terminal multilayer ceramic capacitor 10 can be measured by a microscope.

In the two-terminal multilayer ceramic capacitor 10 illustrated in FIG. 1, the first extended portion 28a of the first inner electrode layer 16a includes the first connection portion 29a connected and disposed to straddle at least two or more of the first extended portions 28a in the lamination direction, between the first extended portions 28a disposed on different dielectric layers 14 positioned on at least one of the first main surface 12a side and the second main surface 12b side, and the second extended portion 28b of the second inner electrode layer 16b has the second connection portion 29b connected and disposed to straddle at least two or more of the second extended portions 28b in the lamination direction, between the second extended portions 28b disposed on different dielectric layers 14 positioned on at least one of the first main surface 12a side and the second main surface 12b side. Accordingly, in the first extended portion 28a of the first inner electrode layer 16a and the second extended portion 28b of the second inner electrode layer 16b positioned on main surface side outer layer portions 20a, 20b sides where separation of the two-terminal multilayer ceramic capacitor 10 is likely to occur, it is possible to enhance close contact strength of the inner electrode layers 16 between the first extended portions 28a positioned on different dielectric layers 14 and between the second extended portions 28b positioned on different dielectric layers 14. As a result, even in a case where a balling phenomenon occurs where the inner electrode layer 16 aggregates in a lateral direction and expands in a lamination direction x, and thus the thickness increases, by heat during firing of the multilayer body 12, in the inner electrode layer 16 positioned on a part of both end surfaces 12e, 12f and main surface side outer layer portions 20a, 20b sides of the multilayer body 12 where separation is likely to occur, the inner electrode layers 16 are firmly connected to each other, and thus it is possible to reduce or prevent the occurrence of separation of the inner electrode layers 16.

### 2. Method of Manufacturing Two-Terminal Multilayer Ceramic Capacitor

Subsequently, an example of a method of manufacturing a two-terminal multilayer ceramic capacitor will be described.

First, a dielectric sheet for a dielectric layer and a conductive paste for an inner electrode layer are prepared. The dielectric sheet and the conductive paste for the inner electrode layer include a binder and a solvent. The binder and the solvent may be known ones.

Then, when forming the dielectric sheet, a paste including a dielectric is applied by, for example, ink jet printing to create a dielectric sheet. At this time, the dielectric sheet on which a pattern of the inner electrode layer is not printed is continuously applied. On the other hand, the dielectric sheet on which a pattern for the first inner electrode layer and a pattern for the second inner electrode layer are printed is discontinuously applied at a portion at which the first connection portion and the second connection portion are to be formed, and when applying a conductive paste for ink jet printing or screen printing inner electrode, the conductive paste for an inner electrode is introduced into the discontinuous portion to form the first connection portion and the second connection portion. At this time, by controlling a width of the discontinuous portion by ink jet printing, it is possible to control the dimension in the length direction that also links the first end surface and the second end surface of the first connection portion and the second connection portion.

In addition, as for the dielectric sheet, the dielectric sheet for an outer layer on which the pattern of the inner electrode layer is not printed is also prepared.

Subsequently, by laminating a predetermined number of the dielectric sheets for an outer layer on which the pattern of the inner electrode layer is not printed, a portion that becomes the second main surface side outer layer portion on the second main surface side is formed. Then, by sequentially laminating a dielectric sheet in which a pattern of the first inner electrode layer is printed on a portion that becomes the second main surface side outer layer portion and a dielectric sheet in which a pattern of the second inner electrode layer is printed to form a structure of an example embodiment of the present invention, a portion that becomes an inner layer portion is formed. Thereafter, by further laminating a predetermined number of dielectric sheets for an outer layer in which the pattern of the inner electrode layer is not printed on the portion that becomes the inner layer portion, a portion that becomes the first main surface side outer layer portion on the first main surface side is formed. Accordingly, a multilayer sheet is prepared.

Subsequently, a multilayer block is prepared by pressing the multilayer sheet in a lamination direction by, for example, using an isostatic press.

By cutting the multilayer block into a predetermined size, a multilayer chip is cut out. At this time, the corner portion and the ridge portion of the multilayer chip may be rounded by, for example, barrel polishing and the like.

Subsequently, the multilayer body 12 is prepared by firing the multilayer chip. A firing temperature depends on the materials of the dielectric layer or the inner electrode layer, but is, for example, preferably about 900° C. or higher and about 1, 400° C. or lower.

### Formation of Outer Electrode

### (a) Case of Baked Layer

In the following description, it is assumed that the base electrode layer is formed of a baked layer. In a case where the baked layer is formed, a conductive paste including a glass component and a metal is prepared, and this is applied, and thereafter subjected to baking treatment to form a base electrode layer.

On the first end surface 12e and the second end surface 12f of the multilayer body 12 obtained by firing, the first base electrode layer 32a of the first outer electrode 30a and the second base electrode layer 32b of the second outer electrode 30b are formed.

In a case where a baked layer is formed as the base electrode layer 32, the conductive paste including a glass component and a metal component is, for example, applied by a method such as dipping, thereafter baking treatment is performed, and a baked layer is formed as the base electrode layer 32. A temperature of the baking treatment at this time is, for example, preferably about 700° C. or higher and about 900° C. or lower.

In addition, in a case where the base electrode layer 32 is formed of a baked layer, the baked layer may include a ceramic component. In this case, a ceramic component may be included instead of the glass component. Both of these may be included.

The ceramic component is preferably, for example, a ceramic material of the same type as the multilayer body 12. In a case where the ceramic component is included in the baked layer, it is preferable that the conductive paste is applied to the multilayer chip before firing, the multilayer chip before firing and the conductive paste applied to the multilayer chip before firing are simultaneously baked (fired), and the multilayer body 12 in which the baked layer is formed. A temperature of the baking treatment (firing temperature) at this time is, for example, preferably about 900° C. or higher and about 1,400° C. or lower.

### (b) Case of Conductive Resin Layer

In a case where the base electrode layer 32 is formed of a conductive resin layer, the conductive resin layer can be formed by the following method. The conductive resin layer may be formed on a surface of the baked layer, or the conductive resin layer may be formed alone directly on the multilayer body 12 without forming the baked layer.

The formation of the conductive resin layer is performed by applying a conductive resin paste including a heat solidifying resin and a metal component on the baked layer or the multilayer body 12, performing heat treatment at a temperature of, for example, about 250° C. or higher and about 550° C. or less, and performing heat solidification on the resin. An atmosphere during heat treatment at this time is, for example, preferably an N₂ atmosphere. In addition, for example, it is preferable to reduce or prevent an oxygen concentration to about 100 ppm or less to prevent the resin from scattering and to prevent various metal components from being oxidized.

As an application method of the conductive resin paste, similar to the method of forming the base electrode layer 32 of a baked layer, for example, a method of extruding the conductive resin paste from a slit and applying thereof or a roller transfer method can be used.

### (c) Case of Thin Film Layer

In addition, in a case where the base electrode layer 32 is formed of a thin film layer, it is possible to form a base electrode layer by covering a site other than a desired portion where the outer electrode 30 is formed by masking or the like, and subjecting the exposed desired portion to a thin film forming method such as a sputtering method or an evaporation method. The base electrode layer formed of a thin film layer is a layer having metal particles deposited having a thickness of, for example, about 1 μm or less.

### Plating Electrode

In addition, the outer electrode may be formed as a plating electrode only with a plating layer without providing the base electrode layer 32. In this case, it is possible to form the outer electrode by the following method.

As for either or each of the first outer electrode 30a and the second outer electrode 30b, a plating layer may be formed directly on a surface of the multilayer body 12 without providing the base electrode layer 32. That is, the two-terminal multilayer ceramic capacitor 10 may have a structure including a plating layer directly electrically connected to the first inner electrode layer 16a and the second inner electrode layer 16b. In performing the plating treatment, either electrolytic plating or electroless plating may be employed, but electroless plating has disadvantages that pretreatment with a catalyst and the like is required to enhance a plating deposition speed, and the process is complicated. Therefore, it is usually preferable to use electrolytic plating. As the plating method, it is preferable to use barrel plating. In addition, depending on the necessity, an upper plating electrode formed on the surface of the lower plating electrode may be similarly formed.

### Preparation of Plating Layer

Subsequently, depending on the necessity, a plating layer is formed on a surface of the base electrode layer 32, a surface of the conductive resin layer, or a surface of the lower plating electrode and a surface of the upper plating electrode.

More specifically, in the present example embodiment, for example, a Ni plating layer and a Sn plating layer are formed as the plating layer 34 on the base electrode layer 32, which is a baked layer. The Ni plating layer and the Sn plating layer are sequentially formed by, for example, a barrel plating method. In performing the plating treatment, either electrolytic plating or electroless plating may be employed. However, electroless plating has disadvantages that pretreatment with a catalyst and the like is required to enhance a plating deposition speed, and the process is complicated. Therefore, it is usually preferable to employ electrolytic plating.

As described above, the two-terminal multilayer ceramic capacitor 10 according to the first example embodiment is manufactured.

### B. Second Example Embodiment

### 1. Three-Terminal Multilayer Ceramic Capacitor

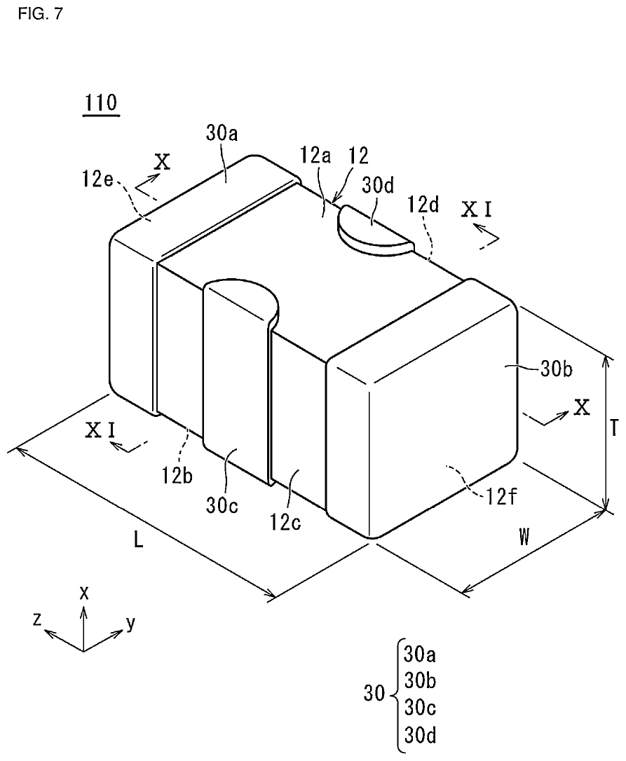

As a multilayer ceramic capacitor according to a second example embodiment of the present invention, a three-terminal multilayer ceramic capacitor 110 will be described with reference to FIGS. 7 to 12.

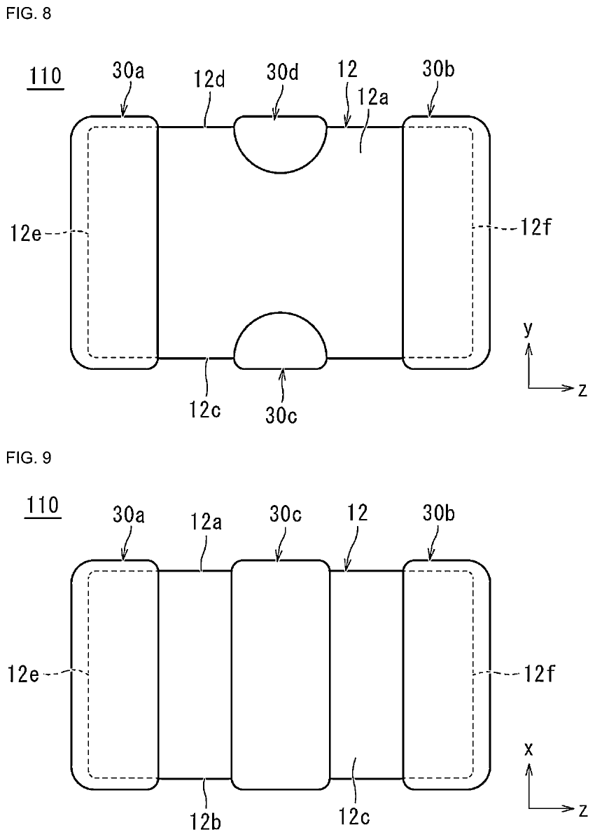

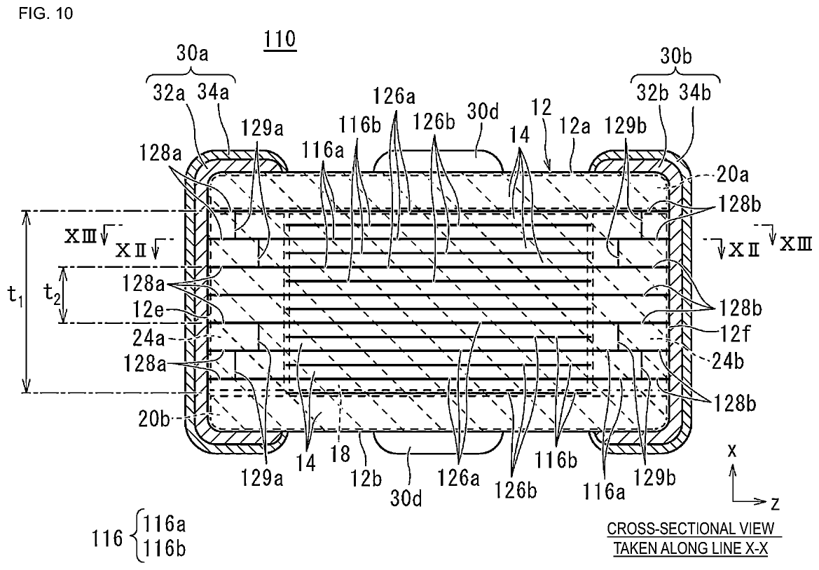

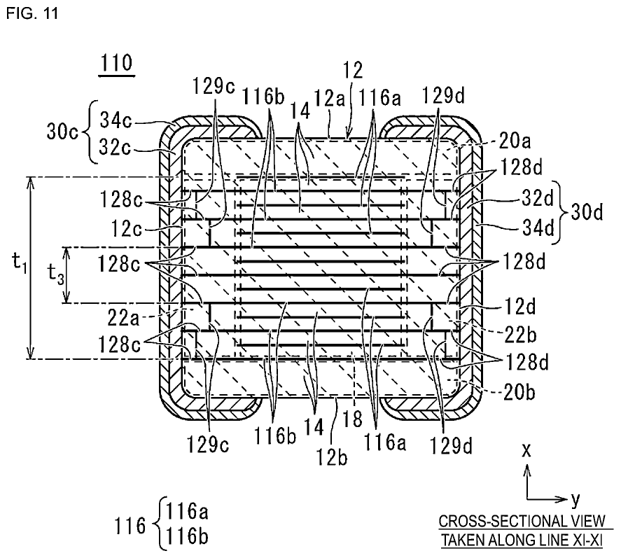

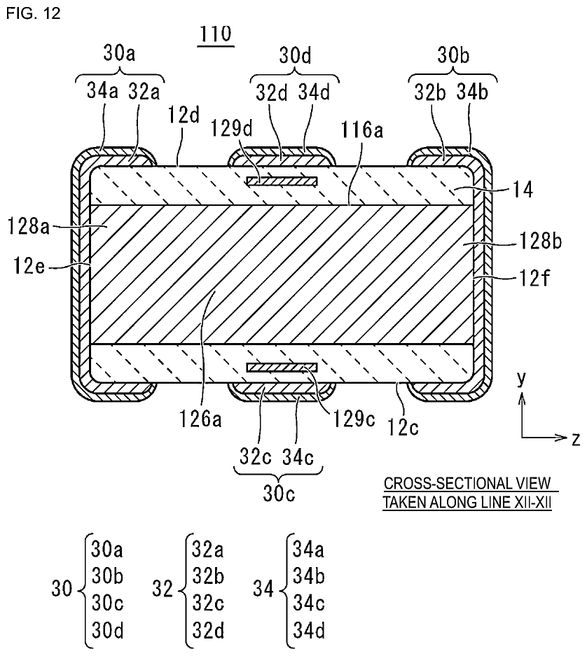

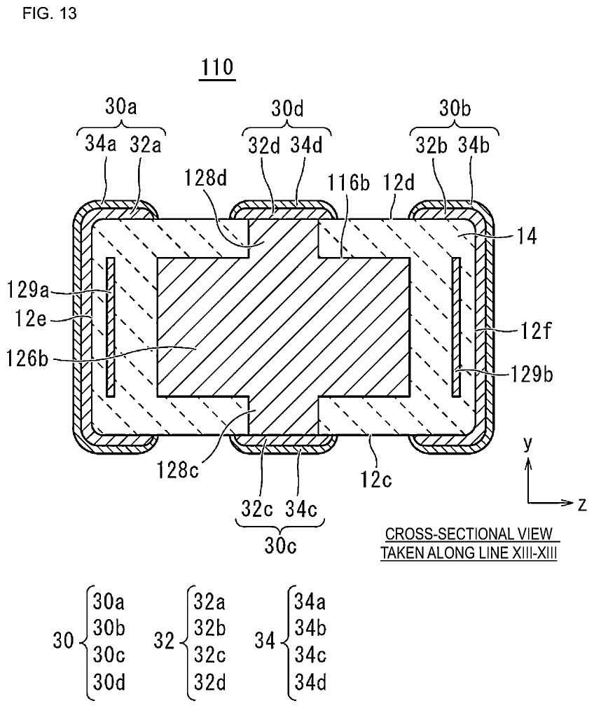

FIG. 7 is an appearance perspective view illustrating an example of a three-terminal multilayer ceramic capacitor according to a second example embodiment of the present invention. FIG. 8 is a top view illustrating an example of a three-terminal multilayer ceramic capacitor according to a second example embodiment of the present invention. FIG. 9 is a front view illustrating an example of a three-terminal multilayer ceramic capacitor according to a second example embodiment of the present invention. FIG. 10 is a cross-sectional view taken along line X-X in FIG. 7. FIG. 11 is a cross-sectional view taken along line XI-XI in FIG. 7. FIG. 12 is a cross-sectional view taken along line XI-XI in FIG. 11. FIG. 13 is a cross-sectional view taken along line XII-XII in FIG. 11.

The multilayer body 12 includes a plurality of laminated dielectric layers 14 and a plurality of inner electrode layers 116 laminated on the dielectric layer 14. The dielectric layer 14 and the inner electrode layer 116 are laminated in the lamination direction x.

The multilayer body 12 includes a first main surface 12a and a second main surface 12b facing each other in the lamination direction x, a first side surface 12c and a second side surface 12d facing each other in the width direction y orthogonal or substantially orthogonal to the lamination direction x, a first end surface 12e and a second end surface 12f facing each other in the length direction z orthogonal or substantially orthogonal to the lamination direction x and the width direction y. Corner portions and ridge portions of the multilayer body 12 are rounded. In addition, the corner portion is a portion where three adjacent surfaces of the multilayer body intersect, and the ridge portion is a portion where two adjacent surfaces of the multilayer body intersect. In addition, unevenness or the like may be provided on portions or all of the first main surface 12a and the second main surface 12b, the first side surface 12c and the second side surface 12d, and the first end surface 12e and the second end surface 12f.

The multilayer body 12 includes an inner layer portion 18 including one or more dielectric layers 14 and a plurality of inner electrode layers 116 disposed thereon. The inner electrode layer 116 includes a first inner electrode layer 116a that extends to the first end surface 12e and the second end surface 12f and a second inner electrode layer 116b that extends to the first side surface 12c and the second side surface 12d, and in the inner layer portion 18, a plurality of the first inner electrode layers 116a and the second inner electrode layers 116b face each other with the dielectric layer 14 interposed therebetween.

The multilayer body 12 includes a first main surface side outer layer portion 20a, which is positioned on the first main surface 12a side, and includes a plurality of the dielectric layers 14 positioned between the first main surface 12a, an outermost surface of the inner layer portion 18 on the first main surface 12a side, and on a straight line of the outermost surface thereof.

Similarly, the multilayer body 12 includes a second main surface side outer layer portion 20b, which is positioned on the second main surface 12b side, and includes a plurality of the dielectric layers 14 positioned between the second main surface 12b, an outermost surface of the inner layer portion 18 on the second main surface 12b side, and on a straight line of the outermost surface thereof.

In addition, the multilayer body 12 includes a first side surface side outer layer portion 22a, which is positioned on the first side surface 12c side, and includes a plurality of dielectric layers 14 positioned between the first side surface 12c and an outermost surface of the inner layer portion 18 on the first side surface 12c side.

Similarly, the multilayer body 12 includes a second side surface side outer layer portion 22b, which is positioned on the second side surface 12d side and includes a plurality of the dielectric layers 14 positioned between the second side surface 12d and an outermost surface of the inner layer portion 18 on the second side surface 12d side.

In addition, the multilayer body 12 includes a first end surface side outer layer portion 24a, which is positioned on the first end surface 12e side and includes the plurality of dielectric layers 14 positioned between the first end surface 12e and an outermost surface of the inner layer portion 18 on the first end surface 12e side.

Similarly, the multilayer body 12 includes a second end surface side outer layer portion 24b, which is positioned on the second end surface 12f side and includes a plurality of the dielectric layers 14 positioned between the second end surface 12f and an outermost surface of the inner layer portion 18 on the second end surface 12f side.

The first main surface side outer layer portion 20a is positioned on the first main surface 12a side. The first main surface side outer layer portion 20a is an aggregate of a plurality of dielectric layers 14 positioned between the first main surface 12a and the inner electrode layer 116 closest to the first main surface 12a.

The second main surface side outer layer portion 20b is positioned on the second main surface 12b side. The second main surface side outer layer portion 20b is an aggregate of a plurality of dielectric layers 14 positioned between the second main surface 12b and the inner electrode layer 116 closest to the second main surface 12b.

The dimension of the multilayer body 12 is not particularly limited.

The material of the dielectric layer 14 is the same or substantially the same as the two-terminal multilayer ceramic capacitor 10, and thus the description thereof is omitted.

In addition, since an average thickness in the lamination direction x of the dielectric layer 14 after firing is also common to the two-terminal multilayer ceramic capacitor 10, the description thereof will be omitted.

The multilayer body 12 includes the plurality of first inner electrode layers 116a and the plurality of second inner electrode layers 116b, as a plurality of the inner electrode layers 116. The plurality of first inner electrode layers 116a and the plurality of second inner electrode layers 116b are embedded to be alternately disposed at equal intervals along the lamination direction x of the multilayer body 12.

As illustrated in FIG. 16, the first inner electrode layer 116a includes a first counter electrode portion 126a opposing the second inner electrode layer 116b, a first extended portion 128a that extends to a surface of the first end surface 12e of the multilayer body 12 from the first counter electrode portion 126a, and a second extended portion 128b that extends to a surface of the second end surface 12f of the multilayer body 12 from the first counter electrode portion 126a. Accordingly, an end portion of the plurality of first extended portions 128a extends to the surface of the first end surface 12e and is exposed from the multilayer body 12, and an end portion of the plurality of second extended portions 128b extends to the surface of the second end surface 12f and is exposed from the multilayer body 12. Therefore, the first inner electrode layer 116a is not exposed to the surfaces of the first side surface 12c and the second side surface 12d of the multilayer body 12.

As illustrated in FIG. 17, the second inner electrode layer 116b has a cross or substantially cross shape, and includes a second counter electrode portion 126b opposing the first inner electrode layer 116a, a third extended portion 128c extending to a surface of the first side surface 12c of the multilayer body 12 from the second counter electrode portion 126b, and a fourth extended portion 128d extending to a surface of the second side surface 12d of the multilayer body 12 from the second counter electrode portion 126b. Accordingly, an end portion of the third extended portion 128c extends to the surface of the first side surface 12c and is exposed from the multilayer body 12, and an end portion of the fourth extended portion 128d extends to the surface of the second side surface 12d and is exposed from the multilayer body 12. Therefore, the second inner electrode layer 116b is not exposed to the surface of the first end surface 12e and the surface of the second end surface 12f of the multilayer body 12.

Four corner portions of the second counter electrode portion 126b in the second inner electrode layer 116b are not chamfered, but may have a chamfered shape. Accordingly, it is possible to reduce or prevent the first inner electrode layer 116a from overlapping the corner of the first counter electrode portion 126a, and to reduce or prevent electric field concentration. As a result, it is possible to reduce or prevent dielectric breakdown of the ceramic capacitor that can occur due to electric field concentration.

The first extended portion 128a includes a first connection portion 129a connected and disposed to straddle at least two or more of the first extended portions 128a in a lamination direction, between the first extended portions 128a disposed on different dielectric layers 14 positioned on at least one of the first main surface 12a side and the second main surface 12b side.

The second extended portion 128b includes a second connection portion 129b connected and disposed to straddle at least two or more of the second extended portions 128b in a lamination direction, between the second extended portions 128b disposed on different dielectric layers 14 positioned on at least one of the first main surface 12a side and the second main surface 12b side.

The third extended portion 128c includes a third connection portion 129c connected and disposed to straddle at least two or more of the third extended portions 128c in a lamination direction, between the third extended portions 128c disposed on different dielectric layers 14 positioned on at least one of the first main surface 12a side and the second main surface 12b side.

The fourth extended portion 128d includes a fourth connection portion 129d connected and disposed to straddle at least two or more of the fourth extended portions 128d in a lamination direction, between the fourth extended portions 128d disposed on different dielectric layers 14 positioned on at least one of the first main surface 12a side and the second main surface 12b side.

The first connection portion 129a is preferably positioned on the first end surface 12e side with respect to about ½ of the dimension in the length direction z of the first end surface side outer layer portion 24a.

The second connection portion 129b is preferably positioned on the second end surface 12f side with respect to about ½ of the dimension in the length direction z of the second end surface side outer layer portion 24b.

The third connection portion 129c is preferably positioned on the first end surface 12e side with respect to about ½ of the dimension in the length direction z of the first side surface side outer layer portion 22a.

The fourth connection portion 129d is preferably positioned on the second end surface 12f side with respect to about ½ of the dimension in the length direction z of the second side surface side outer layer portion 22b.

Accordingly, in a portion in which stress concentration is most likely to occur due to a balling phenomenon where the inner electrode layer 116 aggregates in a lateral direction and expands in a lamination direction x, and thereby the thickness increases, by heat during firing of the multilayer body 12, it is possible to directly further enhance close contact strength between the inner electrode layers 116.

It is preferable that there is a plurality of first connection portions 129a.

It is preferable that there is a plurality of second connection portions 129b.

It is preferable that there is a plurality of third connection portions 129c.

It is preferable that there is a plurality of fourth connection portions 129d.

Accordingly, in a portion in which stress concentration is most likely to occur due to a balling phenomenon where the inner electrode layer 116 aggregates in a lateral direction and expands in a lamination direction x, and thus the thickness increases, by heat during firing of the multilayer body 12, it is possible to directly further enhance close contact strength between the inner electrode layers 116.

The first connection portion 129a is preferably positioned on the first main surface 12a side excluding a central portion in the lamination direction of the inner layer portion 18 and on the second main surface 12b side excluding a central portion in the lamination direction of the inner layer portion 18.

The second connection portion 129b is preferably positioned on the first main surface 12a side excluding the central portion in the lamination direction of the inner layer portion 18 and on the second main surface 12b side excluding the central portion in the lamination direction of the inner layer portion 18.

The third connection portion 129c is preferably positioned on the first main surface 12a side excluding the central portion in the lamination direction of the inner layer portion 18 and on the second main surface 12b side excluding the central portion in the lamination direction of the inner layer portion 18.

The fourth connection portion 129d is preferably positioned on the first main surface 12a side excluding the central portion in the lamination direction of the inner layer portion 18 and on the second main surface 12b side excluding the central portion in the lamination direction of the inner layer portion 18.

Accordingly, while reducing or preventing the occurrence of separation of the inner electrode layers 116, at the central portion of the inner layer portion 18 in the lamination direction, it is possible to maintain the ceramic strength of the multilayer body 12 in a portion where an extended portion of the inner electrode layer 116 is present. Therefore, while reducing or preventing the occurrence of separation of the inner electrode layers 116, in a case where an external impact is applied to the three-terminal multilayer ceramic capacitor 110, it is possible to reduce or prevent the occurrence of breakage, chipping, crack, or the like in the multilayer body 12 of the three-terminal multilayer ceramic capacitor 110.

At this time, the dimension t₂ in the lamination direction of the central portion in the lamination direction of the inner layer portion 18, which is a region where the first connection portion 129a is not disposed, is, for example, preferably about 25% or more and about 75% or less of the dimension t₁ in the lamination direction of the inner layer portion 18.

The dimension t₂ in the lamination direction of the central portion in the lamination direction of the inner layer portion 18, which is a region where the second connection portion 129b is not disposed, is, for example, preferably about 25% or more and about 75% or less of the dimension t₁ in the lamination direction of the inner layer portion 18.

The dimension t₃ in the lamination direction of the central portion in the lamination direction of the inner layer portion 18, which is a region where the third connection portion 129c is not disposed, is, for example, preferably about 25% or more and about 75% or less of the dimension t₁ of the inner layer portion 18 in the lamination direction.

The dimension t₃ in the lamination direction of the central portion in the lamination direction of the inner layer portion 18, which is a region where the fourth connection portion 129d is not disposed, is, for example, preferably about 25% or more and about 75% or less of the dimension t₁ of the inner layer portion 18 in the lamination direction.

Here, in a case where the dimension t₂ in the lamination direction of the central portion in the lamination direction of the inner layer portion 18 in the region where the first connection portion 129a and the second connection portion 129b are not disposed is less than about 25% of the dimension t₁ in the lamination direction of the inner layer portion 18, there is a concern that breakage, chipping, crack, or the like occurs in the multilayer body 12 of the three-terminal multilayer ceramic capacitor 110 in a case where an external impact is applied to the three-terminal multilayer ceramic capacitor 110. In addition, in a case where the dimension t₂ in the lamination direction of the central portion in the lamination direction of the inner layer portion 18 in the region where the first connection portion 129a and the second connection portion 129b are not disposed is greater than about 75% of the dimension t₁ in the lamination direction of the inner layer portion 18, there is a case where it is not possible to sufficiently ensure close contact strength of the inner electrode layers 116 between the first extended portions 128a positioned on different dielectric layers 14 and between the second extended portions 128b positioned on different dielectric layers 14 in an extended portion of the inner electrode layer 116 of the inner layer portion 18 positioned on the main surface side outer layer portions 20a, 20b sides where separation of the three-terminal multilayer ceramic capacitor 110 is likely to occur.

In addition, in a case where the dimension ty in the lamination direction of the central portion in the lamination direction of the inner layer portion 18 in a region where the third connection portion 129c and the fourth connection portion 129d are not disposed is less than about 25% of the dimension t₁ in the lamination direction of the inner layer portion 18, there is a concern that breakage, chipping, crack, or the like occurs in the multilayer body 12 of the three-terminal multilayer ceramic capacitor 110 in a case where an external impact is applied to the three-terminal multilayer ceramic capacitor 110. In addition, the dimension t₃ in the lamination direction of the central portion in the lamination direction of the inner layer portion 18 in the region where the third connection portion 129c and the fourth connection portion 129d are not disposed is greater than about 75% of the dimension t₁ in the lamination direction of the inner layer portion 18, there is a case where it is not possible to sufficiently ensure close contact strength of the inner electrode layers 116 between the first extended portions 128a positioned on different dielectric layers 14 and between the second extended portions 128b positioned on different dielectric layers 14 in an extended portion of the inner electrode layer 116 of the inner layer portion 18 positioned on side surface side outer layer portions 22a, 22b sides where separation of the three-terminal multilayer ceramic capacitor 110 is likely to occur.

The dimension in the length direction z that links the first end surface 12e and the second end surface 12f of the first connection portion 129a is, for example, preferably about 3% or more and about 97% or less with respect to the thickness of the first extended portion 128a of the first inner electrode layer 116a.

The dimension in the length direction z that links the first end surface 12e and the second end surface 12f of the second connection portion 129b is, for example, preferably about 3% or more and about 978 or less with respect to the thickness of the second extended portion 128b of the first inner electrode layer 116a.

The dimension in the length direction z that links the first side surface 12c and the second side surface 12d of the third connection portion 129c is, for example, preferably about 3% or more and about 97% or less with respect to the thickness of the third extended portion 128c of the second inner electrode layer 116b.

The dimension in the length direction z that links the first side surface 12c and the second side surface 12d of the fourth connection portion 129d is, for example, preferably about 3% or more and about 97% or less with respect to the thickness of the fourth extended portion 128d of the second inner electrode layer 116b.

Accordingly, since the electric resistance is higher than that of the inner electrode layer 16 and it is difficult for current to flow, it is possible to prevent changes in electronic characteristics and reduce or prevent separation of the inner electrode layers 116 by including the first connection portion 129a to the fourth connection portion 129d.

The first connection portion 129a and the second connection portion 129b are preferably present by being concentrated at the central portion of the three-terminal multilayer ceramic capacitor 110 in the width direction y.

In addition, the third connection portion 129c and the fourth connection portion 129d are preferably present by being concentrated at the central portion of the three-terminal multilayer ceramic capacitor 110 in the width direction y.

Accordingly, it is possible to further ensure the close contact strength between the inner electrode layers 16 firmly at the central portion of the three-terminal multilayer ceramic capacitor 110 in the width direction y.

A composition of the material of the first inner electrode layer 116a and the second inner electrode layer 116b, and a composition in the layer in the lamination direction x are the same as those of the first inner electrode layer 16a and the second inner electrode layer 16b of the two-terminal multilayer ceramic capacitor 10 of the first example embodiment.

The outer electrode 30 includes a first outer electrode 30a, a second outer electrode 30b, a third outer electrode 30c, and a fourth outer electrode 30d.

The first outer electrode 30a is connected to the first inner electrode layer 116a and disposed on the surface of the first end surface 12e. In addition, the first outer electrode 30a extends from the first end surface 12e of the multilayer body 12 and is also disposed on a part of the first main surface 12a and a part of the second main surface 12b, and a part of the first side surface 12c and a part of the second side surface 12d. In this case, the first outer electrode 30a is electrically connected to the first extended portion 128a of the first inner electrode layer 116a.

The second outer electrode 30b is connected to the first inner electrode layer 116a and disposed on the surface of the second end surface 12f. In addition, the second outer electrode 30b extends from the second end surface 12f of the multilayer body 12 and is also disposed on a portion of the first main surface 12a, a portion of the second main surface 12b, a portion of the first side surface 12c, and a portion of the second side surface 12d. In this case, the second outer electrode 30b is electrically connected to the second extended portion 128b of the first inner electrode layer 116a.

The third outer electrode 30c is connected to the second inner electrode layer 116b and disposed on the surface of the first side surface 12c. In addition, the third outer electrode 30c extends from the first side surface 12c of the multilayer body 12 and is also disposed on a portion of the first main surface 12a and a portion of the second main surface 12b. In this case, the third outer electrode 30c is electrically connected to the third extended portion 128c of the second inner electrode layer 116b.

The fourth outer electrode 30d is connected to the second inner electrode layer 116b and disposed on the surface of the second side surface 12d. In addition, the fourth outer electrode 30d extends from the second side surface 12d of the multilayer body 12 and is also disposed on a portion of the first main surface 12a and a portion of the second main surface 12b. In this case, the fourth outer electrode 30d is electrically connected to the fourth extended portion 128d of the second inner electrode layer 116b.

In the multilayer body 12, the first counter electrode portion 126a of the first inner electrode layer 116a and the second counter electrode portion 126b of the second inner electrode layer 116b face each other with the dielectric layer 14 interposed therebetween to generate electrostatic capacitance. Therefore, electrostatic capacitance can be obtained between the first outer electrode 30a and the second outer electrode 30b to which the first inner electrode layer 116a is connected and the third outer electrode 30c and the fourth outer electrode 30d to which the second inner electrode layer 116b is connected, and characteristics of the capacitor is achieved.

The base electrode layer 32 includes a first base electrode layer 32a, a second base electrode layer 32b, a third base electrode layer 32c, and a fourth base electrode layer 32d.

The first base electrode layer 32a is connected to the first inner electrode layer 116a and disposed on the surface of the first end surface 12e. In addition, the first base electrode layer 32a extends from the first end surface 12e and is also disposed on a portion of the first main surface 12a, a portion of the second main surface 12b, a portion of the first side surface 12c, and a portion of the second side surface 12d. In this case, the first base electrode layer 32a is electrically connected to the first extended portion 128a of the first inner electrode layer 116a.

The second base electrode layer 32b is connected to the first inner electrode layer 116a and disposed on the surface of the second end surface 12f. In addition, the second base electrode layer 32b extends from the second end surface 12f and is also disposed on a portion of the first main surface 12a, a portion of the second main surface 12b, a portion of the first side surface 12c, and a portion of the second side surface 12d. In this case, the second base electrode layer 32b is electrically connected to the second extended portion 128b of the first inner electrode layer 116a.

The third base electrode layer 32c is connected to the second inner electrode layer 116b and disposed on the surface of the first side surface 12c. In addition, the third base electrode layer 32c extends from the first side surface 12c and is also disposed on a portion of the first main surface 12a and a portion of the second main surface 12b. In this case, the third base electrode layer 32c is electrically connected to the third extended portion 128c of the second inner electrode layer 116b.

The fourth base electrode layer 32d is connected to the second inner electrode layer 116b and disposed on the surface of the second side surface 12d. In addition, the fourth base electrode layer 32d extends from the second side surface 12d and is also disposed on a portion of the first main surface 12a and a portion of the second main surface 12b. In this case, the fourth base electrode layer 32d is electrically connected to the fourth extended portion 128d of the second inner electrode layer 116b.

The plating layer 34 includes a first plating layer 34a, a second plating layer 34b, a third plating layer 34c, and a fourth plating layer 34d.

The first plating layer 34a is disposed to cover the surface of the first base electrode layer 32a.

The second plating layer 34b is disposed to cover the surface of the second base electrode layer 32b.

The third plating layer 34c is disposed to cover the surface of the third base electrode layer 32c.

The fourth plating layer 34d is disposed to cover the surface of the fourth base electrode layer 32d.

A composition of the material of the first outer electrode 30a, the second outer electrode 30b, the third outer electrode 30c, and the fourth outer electrode 30d of the outer electrodes 30 of the three-terminal multilayer ceramic capacitor 110 and a configuration in the layer are the same or substantially the same as those of the first outer electrode 30a and the second outer electrode 30b of the outer electrode 30 of the two-terminal multilayer ceramic capacitor 10 of the first example embodiment.

A dimension in the length direction z of the three-terminal multilayer ceramic capacitor 110 including the multilayer body 12 and the first outer electrode 30a to the fourth outer electrode 30d is defined as an L dimension, a dimension in the lamination direction x of the three-terminal multilayer ceramic capacitor 110 including the multilayer body 12 and the first outer electrode 30a to the fourth outer electrode 30d is defined as a T dimension, and a dimension in the width direction y of the three-terminal multilayer ceramic capacitor 110 including the multilayer body 12 and the first outer electrode 30a to the fourth outer electrode 30d is defined as a W dimension.

The dimension of the three-terminal multilayer ceramic capacitor 110 is not particularly limited, but the L dimension in the length direction z is, for example, about 0.2 mm or more and about 11.0 mm or less, the W dimension in the width direction y is, for example, about 0.1 mm or more and about 11.0 mm or less, and the T dimension in the lamination direction x is, for example, about 0.1 mm or more and about 11.0 mm or less. The dimension of the three-terminal multilayer ceramic capacitor 110 can be measured with a microscope.

Accordingly, the three-terminal multilayer ceramic capacitor 110 illustrated in FIG. 6 can have various configurations the same as or similar to the configuration of the two-terminal multilayer ceramic capacitor 10 illustrated in FIG. 1, and various effects depending on the various configurations are exhibited.

### 2. Method of Manufacturing Three-Terminal Multilayer Ceramic Capacitor

Subsequently, an example of a method of manufacturing a three-terminal multilayer ceramic capacitor will be described.

First, a dielectric sheet for a dielectric layer and a conductive paste for an inner electrode layer are prepared. The dielectric sheet and the conductive paste for the inner electrode layer include a binder and a solvent. The binder and the solvent may be known ones.

Then, when forming the dielectric sheet, a paste including a dielectric is applied by, for example, ink jet printing to create a dielectric sheet. At this time, the dielectric sheet on which a pattern of the inner electrode layer is not printed is continuously applied. On the other hand, the dielectric sheet on which a pattern for the first inner electrode layer and a pattern for the second inner electrode layer are printed is discontinuously applied at a portion at which the first connection portion and the second connection portion are to be formed, and when applying a conductive paste for ink jet printing or screen printing inner electrode, the conductive paste for an inner electrode is introduced into the discontinuous portion to form the first connection portion and the second connection portion. At this time, by controlling a width of the discontinuous portion by, for example, ink jet printing, it is possible to control the dimension in the length direction that also links the first end surface and the second end surface of the first connection portion and the second connection portion.

In addition, as for the dielectric sheet, the dielectric sheet for an outer layer on which the pattern of the inner electrode layer is not printed is also prepared.

Subsequently, by laminating a predetermined number of the dielectric sheets for an outer layer on which the pattern of the inner electrode layer is not printed, a portion that becomes the second main surface side outer layer portion on the second main surface side is formed. Then, by sequentially laminating a dielectric sheet in which a pattern of the first inner electrode layer is printed on a portion that becomes the second main surface side outer layer portion and a dielectric sheet in which a pattern of the second inner electrode layer is printed to form a structure of an example embodiment of the present invention, a portion that becomes an inner layer portion is formed. Thereafter, by further laminating a predetermined number of dielectric sheets for an outer layer in which the pattern of the inner electrode layer is not printed on the portion that becomes the inner layer portion, a portion that becomes the first main surface side outer layer portion on the first main surface side is formed. Accordingly, a multilayer sheet is prepared.

Subsequently, a multilayer block is prepared by pressing the multilayer sheet in a lamination direction by, for example, using an isostatic press.

By cutting the multilayer block into a predetermined size, a multilayer chip is cut out. At this time, the corner portion and the ridge portion of the multilayer chip may be rounded by, for example, barrel polishing and the like.

Subsequently, the multilayer body 12 is prepared by firing the multilayer chip. A firing temperature depends on the materials of the dielectric layer or the inner electrode layer, but is, for example, preferably about 900° C. or higher and about 1,400° C. or lower.

### Formation of Outer Electrode

### (a) Case of Baked Layer

In the following description, it is assumed that the base electrode layer is a baked layer. In a case where the baked layer is formed, a conductive paste including a glass component and a metal is prepared, and this is applied, and thereafter subjected to baking treatment to form a base electrode layer.

The third base electrode layer 32c of the third outer electrode 30c is formed on the first side surface 12c of the multilayer body 12 obtained by firing, and the fourth base electrode layer 32d of the fourth outer electrode 30d is formed on the second side surface 12d of the multilayer body 12.

In a case where a baked layer is formed as the base electrode layer 32, a conductive paste including a glass component and a metal component is applied, thereafter a baking treatment is performed, and a baked layer is formed as the base electrode layer 32. A temperature of the baking treatment at this time is, for example, preferably about 700° C. or higher and about 900° C. or lower.

Here, various methods can be used as the method of forming a baked layer. For example, a method of applying a conductive paste by extruding thereof from a slit can be used. In the case of this method, by increasing an extrusion amount of the conductive paste, the base electrode layer 32 can be formed not only on the first side surface 12c and the second side surface 12d but also on a part of the first main surface 12a and a part of the second main surface 12b.

In addition, a baked layer can be formed by using a roller transfer method. In the case of the roller transfer method, the base electrode layer 32 can be formed not only on the first side surface 12c and the second side surface 12d but also on a part of the first main surface 12a and a part of the second main surface 12b, and the base electrode layer 32 can be formed on a portion of the first main surface 12a and a portion of the second main surface 12b by increasing a pressing pressure when the roller transfer.

Subsequently, the first base electrode layer 32a of the first outer electrode 30a is formed on the first end surface 12e of the multilayer body 12 obtained by firing, and the second base electrode layer 32b of the second outer electrode 30b is formed on the second end surface 12f of the multilayer body 12.

Similar to during the formation of each of the base electrode layers 32 of the third outer electrode 30c and the fourth outer electrode 30d, in a case where a baked layer is formed as the base electrode layer 32, a conductive paste including a glass component and a metal component is applied, and thereafter, baking treatment is performed, and a baked layer is formed as the base electrode layer 32. A temperature of the baking treatment at this time is, for example, preferably about 700° C. or higher and about 900° C. or lower.

In addition, as a method of forming a baked layer as the base electrode layer 32 of the first outer electrode 30a and the second outer electrode 30b, a conductive paste for the base electrode layer is formed to extend not only on the first end surface 12e and the second end surface 12f but also on a portion of the first main surface 12a, a portion of the second main surface 12b, a portion of the first side surface 12c, and a portion of the second side surface 12d by a dipping method.

Regarding the baking treatment, the third base electrode layer 32c of the third outer electrode 30c, the fourth base electrode layer 32d of the fourth outer electrode 30d, the first base electrode layer 32a of the first outer electrode 30a, and the second base electrode layer 32b of the second outer electrode 30b may be simultaneously baked, or each of the third base electrode layer 32c of the third outer electrode 30c and the fourth base electrode layer 32d of the fourth outer electrode 30d, and the first base electrode layer 32a of the first outer electrode 30a and the second base electrode layer 32b of the second outer electrode 30b may be separately baked.

### (b) Case of Conductive Resin Layer

In a case where the base electrode layer 32 is formed of a conductive resin layer, the conductive resin layer can be formed by, for example, the following method. The conductive resin layer may be formed on a surface of the baked layer, or the conductive resin layer may be formed alone directly on the multilayer body 12 without forming the baked layer.

A method of forming a conductive resin layer is performed by applying a conductive resin paste including a heat solidifying resin and a metal component on a baked layer or a multilayer body 12, performing heat treatment at a temperature of, for example, about 250° C. or higher and about 550° C. or lower, and performing heat solidification on a resin. An atmosphere during heat treatment at this time is, for example, preferably an N₂ atmosphere. In addition, it is preferable to reduce or prevent an oxygen concentration to, for example, about 100 ppm or less to prevent the resin from scattering and to prevent various metal components from being oxidized.

As an application method of the conductive resin paste, similar to the method of forming the base electrode layer 32 of a baked layer, for example, a method of extruding the conductive resin paste from a slit and applying thereof or a roller transfer method can be used.

### (c) Case of Thin Film Layer

In addition, in a case where the base electrode layer 32 is a thin film layer, it is possible to form a base electrode layer by covering a site other than a desired portion where the outer electrode 30 is formed by, for example, masking or the like, and subjecting the exposed desired portion to a thin film forming method such as, for example, a sputtering method or an evaporation method. The base electrode layer formed of a thin film layer is a layer having metal particles deposited having a thickness of, for example, about 1 μm or less.

### Plating Electrode

In addition, the outer electrode may be formed as a plating electrode only with a plating layer without providing the base electrode layer 32. In this case, for example, it is possible to form the outer electrode by the following method.

In addition, for any or each of the first outer electrode 30a to the fourth outer electrode 30d, a plating layer may be formed directly on the surface of the multilayer body 12 without providing the base electrode layer 32. In other words, the three-terminal multilayer ceramic capacitor 110 may have a structure including a plating layer directly electrically connected to the first inner electrode layer 116a and the second inner electrode layer 116b. In performing the plating treatment, either electrolytic plating or electroless plating may be used, but electroless plating has disadvantages that pretreatment with a catalyst and the like is required to enhance a plating deposition speed, and the process is complicated. Therefore, it is usually preferable to employ electrolytic plating. As the plating method, it is preferable to use barrel plating. In addition, depending on the necessity, an upper plating electrode formed on the surface of the lower plating electrode may be similarly formed.

### Preparation of Plating Layer

Subsequently, depending on the necessity, a plating layer is formed on a surface of the base electrode layer 32, a surface of the conductive resin layer, or a surface of the lower plating electrode and a surface of the upper plating electrode.

More specifically, in the present example embodiment, for example, a Ni plating layer and a Sn plating layer are formed as the plating layer 34 on the base electrode layer 32, which is a baked layer. The Ni plating layer and the Sn plating layer are sequentially formed by, for example, a barrel plating method. In performing the plating treatment, either electrolytic plating or electroless plating may be used. However, electroless plating has disadvantages that pretreatment with a catalyst and the like is required to enhance a plating deposition speed, and the process is complicated. Therefore, it is usually preferable to use electrolytic plating.

As described above, the three-terminal multilayer ceramic capacitor 110 according to the second example embodiment is manufactured.

Including what has been described above, the present invention can add various modifications in terms of the configuration, shape, material, amount, position, or disposition on the above-described example embodiment without departing from the range of the technical concept and the object of the present invention, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers and a plurality of inner electrode layers laminated on the plurality of dielectric layers, a first main surface and a second main surface facing each other in a lamination direction, a first end surface and a second end surface facing each other in a length direction orthogonal or substantially orthogonal to the lamination direction, and a first side surface and a second side surface facing each other in a width direction orthogonal or substantially orthogonal to the lamination direction and the length direction;
a first outer electrode on the first end surface; and
a second outer electrode on the second end surface; wherein
the plurality of inner electrode layers include a plurality of first inner electrode layers and a plurality of second inner electrode layers alternately provided on different dielectric layers;
the plurality of first inner electrode layers include a plurality of first counter electrode portions facing the second inner electrode layers and a plurality of first extended portions extending from the plurality of first counter electrode portions and extending to the first end surface;
the plurality of second inner electrode layers include a plurality of second counter electrode portions opposing the first inner electrode layers and a plurality of second extended portions extending from the plurality of second counter electrode portions and extending to the first side surface;
the plurality of first extended portions each include a first connection portion connected to straddle at least two or more of the plurality of first extended portions in the lamination direction, between the plurality of first extended portions positioned on the different dielectric layers on at least a first main surface side or at least a second main surface side; and
the plurality of second extended portions each include a second connection portion connected to straddle at least two or more of the plurality of second extended portions in the lamination direction, between the second extended portions positioned on the different dielectric layers on at least the first main surface side or at least the second main surface side.

2. The multilayer ceramic capacitor according to claim 1, wherein
the multilayer body includes an inner layer portion in which the plurality of inner electrode layers are opposed to each other;
a first end surface side outer layer portion located on a first end surface side and including the plurality of dielectric layers positioned between the first end surface and an outermost surface of the inner layer portion on the first end surface side; and
a second end surface side outer layer portion located on a second end surface side and including the plurality of dielectric layers positioned between the second end surface and an outermost surface of the inner layer portion on the second end surface side;
the first connection portion is located on the first end surface side with respect to about ½ of a dimension in the length direction of the first end surface side outer layer portion; and
the second connection portion is located on the second end surface side with respect to about ½ of a dimension in the length direction of the second end surface side outer layer portion.

3. The multilayer ceramic capacitor according to claim 1, further comprising a plurality of the first connection portions and the a plurality of the second connection portions.

4. The multilayer ceramic capacitor according to claim 1, wherein the first connection portion and the second connection portion are located on at least one of the first main surface side excluding a central portion in the lamination direction of the inner layer portion and the second main surface side excluding a central portion in the lamination direction of the inner layer portion.

5. The multilayer ceramic capacitor according to claim 1, wherein each of the plurality of dielectric layers includes BaTiO₃, CaTiO₃, SrTiO₃, or CaZrO₃ as a main component.

6. The multilayer ceramic capacitor according to claim 5, wherein each of the plurality of dielectric layers includes a Mn compound, a Fe compound, a Cr compound, a Co compound, or a Ni compound as a sub-component.

7. The multilayer ceramic capacitor according to claim 1, wherein a thickness of each of the plurality of dielectric layers is about 0.5 μm or more and about 10.0 μm or less.

8. The multilayer ceramic capacitor according to claim 1, wherein a number of the plurality of dielectric layers is 15 or more and 700 or less.

9. The multilayer ceramic capacitor according to claim 1, wherein each of the plurality of inner electrode layers includes Cu, Ag, Pd, or Au, or an alloy including at least one of Cu, Ag, Pd, or Au.

10. The multilayer ceramic capacitor according to claim 1, wherein a thickness of each of the plurality of inner electrode layers is about 0.4 μm or more and about 0.8 μm or less.

11. A multilayer ceramic capacitor comprising:
a multilayer body including a plurality of laminated dielectric layers, a plurality of inner electrode layers laminated on the plurality of dielectric layers, a first main surface and a second main surface facing each other in a lamination direction, a first end surface and a second end surface facing each other in a length direction orthogonal or substantially orthogonal to the lamination direction, and a first side surface and a second side surface facing each other in a width direction orthogonal or substantially orthogonal to the lamination direction and the length direction;
a plurality of first inner electrode layers on the plurality of dielectric layers and extending to the first end surface and the second end surface;
a plurality of second inner electrode layers on the plurality of dielectric layers and extending to the first side surface and the second side surface;
a first outer electrode on the first end surface and connected to the first inner electrode layers;
a second outer electrode on the second end surface and connected to the first inner electrode layers;
a third outer electrode on the first side surface and connected to the second inner electrode layers; and
a fourth outer electrode on the second side surface and connected to the second inner electrode layers; wherein
the plurality of first inner electrode layers include a plurality of first counter electrode portions opposing the plurality of second inner electrode layers with the plurality of dielectric layers interposed therebetween, a plurality of first extended portions extending from the plurality of first counter electrode portions and extending to the first end surface, and a plurality of second extended portions extending from the plurality of first counter electrode portions and extending to the second end surface;
the plurality of second inner electrode layers include a plurality of second counter electrode portions opposing the plurality of first inner electrode layers with the plurality of dielectric layers interposed therebetween, and a plurality of third extended portions extending from the plurality of second counter electrode portions and extending to the first side surface, and a plurality of fourth extended portions extending from the plurality of second counter electrode portions and extending to the second side surface;
the plurality of first extended portions each include a first connection portion connected to straddle at least two or more of the plurality of first extended portions in the lamination direction, between the plurality of first extended portions located on different dielectric layers on at least a first main surface side or at least a second main surface side;
the plurality of second extended portions each include a second connection portion connected to straddle at least two or more of the plurality of second extended portions in the lamination direction, between the plurality of second extended portions on the different dielectric layers on at least the first main surface side or at least the second main surface side;
the plurality of third extended portions each include a third connection portion connected to straddle at least two or more of the plurality of third extended portions in the lamination direction, between the plurality of third extended portions located on the different dielectric layers on at least the first main surface side or at least the second main surface side; and
the plurality of fourth extended portions each include a fourth connection portion connected to straddle at least two or more of the plurality of fourth extended portions in the lamination direction, between the plurality of fourth extended portions located on the different dielectric layers on at least the first main surface side or at least the second main surface side.

12. The multilayer ceramic capacitor according to claim 11, wherein
the multilayer body includes an inner layer portion in which the plurality of inner electrode layers are opposed to each other;
a first side surface side outer layer portion located on a first side surface side and including the plurality of dielectric layers positioned between the first side surface and an outermost surface of the inner layer portion on the first side surface side;
a second side surface side outer layer portion located on a second side surface side and including the plurality of dielectric layers located between the second side surface and an outermost surface of the inner layer portion on the second side surface side;
a first end surface side outer layer portion located on a first end surface side and including the plurality of dielectric layers located between the first end surface and an outermost surface of the inner layer portion on the first end surface side;
a second end surface side outer layer portion located on a second end surface side and including the plurality of dielectric layers located between the second end surface and an outermost surface of the inner layer portion on the second end surface side;
the first connection portion is located on the first end surface side with respect to about ½ of a dimension in the length direction of the first end surface side outer layer portion;
the second connection portion is located on the second end surface side with respect to about ½ of a dimension in the length direction of the second end surface side outer layer portion;
the third connection portion is located on the first side surface side with respect to about ½ of a dimension in the width direction of the first side surface side outer layer portion; and
the fourth connection portion is located on the second side surface side with respect to about ½ of a dimension in the width direction of the second side surface side outer layer portion.

13. The multilayer ceramic capacitor according to claim 11, further comprising a plurality of the first connection portions, the second connection portions, the third connection portions, and the fourth connection portions.

14. The multilayer ceramic capacitor according to claim 11, wherein the first connection portion, the second connection portion, the third connection portion, and the fourth connection portion are located on at least any one of the first main surface side excluding a central portion in a height direction of the inner layer portion and the second main surface side excluding a central portion in a height direction of the inner layer portion.

15. The multilayer ceramic capacitor according to claim 11, wherein each of the plurality of dielectric layers includes BaTiO₃, CaTiO₃, SrTiO₃, or CaZrO₃ as a main component.

16. The multilayer ceramic capacitor according to claim 15, wherein each of the plurality of dielectric layers includes a Mn compound, a Fe compound, a Cr compound, a Co compound, or a Ni compound as a sub-component.

17. The multilayer ceramic capacitor according to claim 11, wherein a thickness of each of the plurality of dielectric layers is about 0.5 μm or more and about 10.0 μm or less.

18. The multilayer ceramic capacitor according to claim 11, wherein a number of the plurality of dielectric layers is 15 or more and 700 or less.

19. The multilayer ceramic capacitor according to claim 11, wherein each of the plurality of inner electrode layers includes Cu, Ag, Pd, or Au, or an alloy including at least one of Cu, Ag, Pd, or Au.

20. The multilayer ceramic capacitor according to claim 11, wherein a thickness of each of the plurality of inner electrode layers is about 0.4 μm or more and about 0.8 μm or less.
